(19) United States
(12) Patent Application Publication
(10) Pub. No.: US 2006/0087699 A1
(43) Pub. Date: Apr. 27, 2006

(54) Image processing apparatus, control method of the same, and storage medium

(75) Inventor: Masatoshi Matsuhira, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/232,924

(22) Filed: Sep. 23, 2005

(30) Foreign Application Priority Data
Sep. 28, 2004 (JP) 2004-282534
Sep. 28, 2004 (JP) 2004-282535
Sep. 28, 2004 (JP) 2004-282536

(51) Int. Cl. H04N 1/40

(52) U.S. Cl. 358/448

(57) ABSTRACT

When starting point restoring information used for rotation processing and an automatic correcting parameter used for automatic correction processing exist as pre-collection information corresponding to an image file associated with a print instruction, the pre-collection information is read out and obtained from a data buffer (S100 to S120). When no corresponding pre-collection information exists, pre-collection information obtaining processing is executed to obtain pre-collection information, and then the pre-collection information is stored in association with the image file in the data buffer (S130) By using the pre-collection information thus obtained, the image file is subjected to the automatic correction processing and the rotation processing and printed (S140 to 250).

### BACKGROUND OF THE INVENTION

1. Field of the Invention

The present invention relates to an image processing apparatus, a control method of the image processing apparatus and a storage medium, and more particularly to an image processing apparatus for subjecting predetermined image processing to an image file and outputting the image file thus processed, a control method for the image processing apparatus, and a storage medium storing an image processing program for subjecting predetermined image processing to an image file and outputting the image file thus processed.

2. Description of the Prior Art

Conventionally, this type of image processing apparatus is an apparatus for detecting whether an object such as the face of a character or the like is contained in an input image file and identifying an image content on the basis of the detection result, and also setting correction parameters to correct the image file (for example, JP-A-2004-236110) has been proposed. In this apparatus, when the face of a character is detected, a flesh color area is detected or pixels corresponding to an eye or mouth are detected.

### SUMMARY OF THE INVENTION

However, the image processing apparatus described above may induce an increase in the processing time, etc., because it is required to obtain image information of the whole image file, etc., in order to carry out the processing of detecting an object. When the image processing apparatus as described above is applied to, for example, a printer, the increase in the processing time causes an increase in a standby time needed until the printing is started, and thus it is desired to shorten the processing time and enhance the efficiency of the processing to the utmost extent.

Furthermore, in the image processing apparatus described above, when an object such as the face of a character or the like is detected, it is carried out while considering the positional relationship of pixels corresponding to an eye or mouth or the arrangement of the object to the overall image, and thus there is a case where detection of an object or identification of an image content cannot be correctly performed in accordance with the orientation of the image. For example, when the image processing apparatus as described above can be applied to a printer, in some cases, an image is rotated and then printed in accordance with the setting of printing layout or the orientation of a sheet for printing. Therefore, in connection with the rotation of the image, any disadvantage may occur in the detection of the object or the identification of the image content.

An image processing apparatus, a control method for the same and a storage medium according to the present invention have an object to shorten the processing time when image processing is conducted on an image file. Furthermore, the image processing apparatus, the control method for the same and the storage medium according to the present invention have an object to carry out the image processing more efficiently. Still furthermore, the image processing apparatus, the control method for the same and the storage medium according to the present invention have an object to carry out detection of an object and identification of image content more properly. Or, the image processing apparatus, the control method for the same and the storage medium according to the present invention have an object to carry out image correction processing more properly when an image is rotated and output.

The image processing apparatus, the control method for the same and the storage medium according to the present invention adopt the following means in order to attain at least one of the objects described above.

The present invention is directed to an image processing apparatus for subjecting an image file to predetermined image processing and then outputting the image file thus processed. The image processing apparatus includes: an information storage module for storing pre-collection information in association with an image file, the pre-collection information being used when the image file is subjected to the predetermined image processing and the pre-collection information collectable on the basis of the image file; and an image processing module in which when it is instructed to subject a designated image file of image files stored in a predetermined storage medium to predetermined image processing, and when pre-collection information associated with the image file does not exist in the information storage module, the pre-collection information is collected on the basis of the designated image file and stored in association with the image file in the information storage module, and the image file is subjected to the predetermined image processing by using the pre-collection information and then output, and when pre-collection information associated with the image file exists in the information storage module, the image file is subjected to the predetermined image processing by using the pre-collection information and then output.

According to the first image processing apparatus of the present invention, pre-collection information used when image files are subjected to predetermined image processing is stored in association with the image file in an information storage module. In a case where it is instructed to carry out the predetermined image processing on an image file, and if the pre-collection information associated with the image file does not exist, the pre-collection information thus stored is collected on the basis of the image file, stored in the information storage module, and subjected to the predetermined image processing. If the pre-collection information corresponding to the image file exists, the pre-collection information is subjected to the predetermined image processing and output. Accordingly, the pre-collection information is stored in association with the image files, and thus with respect to the image files for which the pre-collection information is once collected, they can be subjected to the next image processing by using the pre-collection information. As a result, it is unnecessary to repetitively carry out the processing of collecting the pre-collection information, so that the processing time needed when the image file is subjected to the image processing can be shortened, and also the image processing can be more efficiently carried out.

The first image processing apparatus of the present invention as described above may be equipped with an information clear module for clearing the pre-collection information stored in the information storage module at a predetermined timing, whereby unnecessary pre-collection information, etc., can be cleared. In this case, the predetermined storage medium may be detachably mounted in the image processing apparatus, and the predetermined timing may be set to at least one of a securing timing of the predetermined storage medium and a detaching time of the predetermined storage medium. Accordingly, the pre-collection information can be cleared at the securing time or detaching timing of the detachably mounted storage medium. The “predetermined timing” may be set to an ON/OFF timing of a power source of the image processing apparatus or the like.

In the first image processing apparatus of the present invention, the information storage module may be structured so as to store the pre-collection information in association with the image file by using a corresponding relationship managing table for managing the corresponding relationship between identification information of the image file and identification information of the pre-collection information. Accordingly, the pre-collection information and the image file can be associated with each other by using a corresponding relationship managing table. In this case, identification information of the image file may be set to address information indicating a physical position of the image file in the predetermined storage medium, or identification information of the pre-collection information may be set to address information indicating a physical position of the pre-collection information in the information storage module, whereby the access speed to the image files or the pre-collection information can be increased.

Further, in the first image processing apparatus of the present invention, the image file may be compressed in a predetermined format, and the pre-collection information may be information that can be collected by sequentially restoring the image file from the head thereof. Accordingly, it is unnecessary to repetitively carry out the processing of sequentially restoring the image file to its original state from the head thereof and thus the effect of shortening the processing time and enhancing the efficiency of the processing is more remarkable. In this case, the predetermined image processing may be image automatic correction processing of sequentially restoring the image file from the head thereof to obtain pixel information, calculating characteristic information indicating the characteristics of the image file on the basis of the pixel information thus obtained, calculating a correcting parameter on the basis of the characteristic information thus calculated, generating a lookup table for converting the pixel information on the basis of the correcting parameter, and converting the pixel information of the image file on the basis of the lookup table thus generated to correct the image file, and the pre-collection information is anyone of the pixel information, the characteristic information, the correcting parameter and the lookup table, and the predetermined image processing is rotated image generating processing of sequentially restoring the image file from the head thereof to obtain starting point restoring information for restoring the image file with a predetermined position of the image file as a starting point, and restoring the image file with the predetermined position as the starting point on the basis of the starting point restoring information thus obtained, whereby a post-rotation image when the image is rotated in a predetermined direction by a predetermined angle is sequentially generated from the upper end, and the pre-collection information is the starting point restoring information. Accordingly, the processing time when the image automatic correction processing or the rotated image generating processing is conducted on the image file can be shortened, and also the image processing can be more efficiently performed.

Alternatively, in the first image processing apparatus of the present invention, wherein the information storage module may be structured to store the pre-collection information in association with the combination of the image file and a processing pattern of the predetermined image processing, and an instruction for subjecting to the predetermined image processing may be an instruction containing an indication of the processing pattern of the predetermined image processing, and wherein when the pre-collection information relating to the combination of the image file and the processing pattern does not exist in the information storage module, the image processing module may collect the pre-collection information on the basis of the image file and the processing pattern, store the pre-collection information thus collected in association with the combination of the image file and the processing pattern in the information storage module, subjects the image file to predetermined image processing by using the pre-collection information and outputs the image file thus processed. When the pre-collection information relating to the combination of the image file and the processing pattern exists in the information storage module, the image file may be subjected to the predetermined image processing by using the pre-collection information. Accordingly, the present invention can also be adapted to a case where the pre-collection information is associated with the combination of an image file and a processing pattern (that is, a case where the pre-collection information varies in accordance with the processing pattern of the predetermined image processing). Here, the “processing pattern” corresponds to the processing pattern of the processing of correcting an image file when the predetermined image processing is the image automatic correcting processing, and it corresponds to the direction and angle pattern of rotating the image file when the predetermined image processing is the rotated image generating processing.

The present invention is also directed to a method for controlling an image processing apparatus having an information storage module for storing information. In the method for controlling an image processing apparatus, in a case where it is instructed that predetermined image processing is carried out on an image file designated from image files stored in a predetermined storage medium, and when the pre-collection information relating to the image file does not exist in the information storage module, the pre-collection information is collected on the basis of the image file and stored in association with the image file in the information storage module, and the image file may be subjected to the predetermined image processing by using the pre-collection information and then output, while when the pre-collection information relating to the image file exists in the information storage module, the image file may be subjected to the predetermined image processing by using the pre-collection information and then output.

According to the method for controlling an image processing apparatus of the present invention, pre-collection information used when image files are subjected to predetermined image processing is stored in association with the image file in an information storage module. In a case where it is instructed to carry out the predetermined image processing on an image file, and if the pre-collection information associated with the image file does not exist, the pre-collection information thus stored is collected on the basis of the image file, stored in the information storage module, and subjected to the predetermined image processing. If the pre-collection information corresponding to the image file exists, the pre-collection information is subjected to the predetermined image processing and output. Accordingly, the pre-collection information is stored in association with the image files, and thus with respect to the image files for which the pre-collection information is once collected, they can be subjected to the next image processing by using the pre-collection information. As a result, it is unnecessary to repetitively carry out the processing of collecting the pre-collection information, so that the processing time needed when the image file is subjected to the image processing can be shortened, and also the image processing can be more efficiently carried out.

The present invention is also directed to a first storage medium for storing therein an image processing program that is installed in an image processing apparatus having an information storage module for storing information to subject an image file to predetermined image processing and output the image file thus processed. In a case where it is instructed that predetermined image processing is carried out on an image file designated from image files stored in a predetermined storage medium, and when the pre-collection information relating to the image file does not exist in the information storage module, the image processing program collects the pre-collection information on the basis of the image file and stores the pre-collection information thus collected in association with the image file in the information storage module, subjects the image file to the predetermined image processing by using the pre-collection information and then output, the image file thus processed, while when the pre-collection information relating to the image file exists in the information storage module, the image processing program subjects the image file to the predetermined image processing by using the pre-collection information and outputs the image file thus processed.

According to the first storage medium of the present invention, by installing and starting a program for an image processing apparatus, pre-collection information used when an image file is subjected to predetermined image processing may be stored in association with the image file in an information storage module, and in a case where it is instructed to carry out the predetermined image processing on an image file, and if the pre-collection information associated with the image file does not exist, the pre-collection information thus stored may be collected on the basis of the image file, stored in the information storage module, subjected to the predetermined image processing while if the pre-collection information corresponding to the image file exists, the pre-collection information is subjected to the predetermined image processing and output. Accordingly, the pre-collection information is stored in association with the image files, and thus with respect to the image files for which the pre-collection information is once collected, they can be subjected to the next image processing by using the pre-collection information. As a result, it is unnecessary to repetitively carry out the processing of collecting the pre-collection information, so that the processing time needed when the image file is subjected to the image processing can be shortened, and also the image processing can be more efficiently carried out.

The present invention is also directed to a second image processing apparatus for subjecting an image file to predetermined image processing and outputting the image file thus processed. In a case where it is instructed that predetermined image processing is carried out on a designated image file of image files stored in a predetermined storage medium, and when the image file is beforehand added with pre-collection information that is used to carry out the predetermined image processing and collectable on the basis of the image file, the image file is subjected to the predetermined image processing by using the pre-collection information thus added and then output, and when the pre-collection information is not beforehand added to the image file, the pre-collection information is collected on the basis of the image file, the image file is added with the pre-collection information thus collected and stored in the predetermined storage medium, and the image file is subjected to the predetermined image processing by using the pre-collection information and then output.

According to the second image processing apparatus of the present invention, in a case where it is instructed to subject an image file to predetermined image processing, and when pre-collection information is added to the image file, the image file is subjected to the predetermined image processing by using the pre-collection information thus added and then output while when no pre-collection information is added to the image file, the pre-collection information is collected on the basis of the image file and added to the image file, and also the image file is subjected to the predetermined image processing by using the pre-collection information thus collected and then output. Accordingly, with respect to the image files which have been once subjected to the image processing, they are added with the pre-collection information, and they can be subjected to the next image processing by using the pre-collection information thus added. As a result, it is unnecessary to repetitively carry out the processing of collecting the pre-collection information, so that the processing time when the image file is subjected to the image processing can be shortened, and also the image processing can be more efficiently carried out.

According to the second image processing apparatus of the present invention, the image processing module may embed the pre-collection information as a part of the image file to thereby add the pre-collection information to the image file. In this case, the image processing module may be structured so as to embed the pre-collection information in an area at the rear side of an image data storing area in each area constituting the image file to thereby add the pre-collection information to the image file. Accordingly, the effect of the embedding of the pre-collection information on the image data (for example, change of the physical position of the image data or the like) can be suppressed. Also, the image processing module may be structured so as to embed the pre-collection information at the last portion of the image file to thereby add the image file with the pre-collection information. Accordingly, the pre-collection information can be embedded to the backmost portion of the image file. As a result, even an image processing apparatus which does not correspond to an image file having pre-collection information embedded therein can easily deal with the image file by disregarding the pre-collection information. Furthermore, the image file may be set to a JPEG-format type file, and the image processing module can add the pre-collection information to the image file by embedding the pre-collection information into an application marker segment in the JPEG format. Accordingly, the pre-collection information can be embedded by using the application marker segment.

The second image processing apparatus of the present invention, wherein the image processing module may be structured to as to store the pre-collection information as a pre-collection information file based on a predetermined format that is linked to the image file, thereby adding the image file with the pre-collection information. Accordingly, the pre-collection information can be added without changing the content of the image file. In this case, the image processing module can link the pre-collection information file and the image file to each other by setting the file name of the pre-collection information file by using at least a part of the file name of the image file. In this case, the image file and the pre-collection information file can be linked to each other by using the file name of the image file or pre-collection information file. In this case, for example, the file names of the image file and the pre-collection information file may be set so that only the extensions thereof are different from each other.

In the second image processing apparatus of the present invention, the image file may be compressed in a predetermined format, and the pre-collection information may be information that can be collected by sequentially restoring the image file from the head thereof. Accordingly, it is unnecessary to repetitively carry out the processing of sequentially restoring an image file to its original state from the head thereof, and thus the effect of shortening the processing time and enhancing the efficiency of the processing is more remarkable. In this case, the predetermined image processing may be image automatic correction processing of sequentially restoring the image file from the head thereof to obtain pixel information, calculating characteristic information representing the characteristics of the image file on the basis of the pixel information thus obtained, calculating a correcting parameter on the basis of the characteristic information thus calculated, generating a lookup table for converting the pixel information on the basis of the correcting parameter thus calculated, and converting the pixel information of the image file on the basis of the lookup table thus generated to thereby correct the image file, and the pre-collection information may be any one of the pixel information, the characteristic information, the correcting parameter and the lookup table. The predetermined image processing may be rotated image generating processing of sequentially restoring the image file from the head thereof to obtain starting point restoring information for restoring the image file with a predetermined position of the image file as a starting point, and restoring the image file with the predetermined position as the starting point on the basis of the starting point restoring information thus obtained, whereby a post-rotation image when the image is rotated in a predetermined direction by a predetermined angle is sequentially generated from the upper end. The pre-collection information may be the starting point restoring information. Accordingly, the processing time when the image file is subjected to the image automatic correction processing or the rotated image generating processing can be shortened, and also the image processing described above can be more efficiently performed.

The present invention is also directed to a first image processing method for subjecting an image file to predetermined image processing and outputting the image file thus processed. In a case where it is instructed that predetermined image processing is carried out on a designated image file of image files stored in a predetermined storage medium, and when the image file is beforehand added with pre-collection information that is used to carry out the predetermined image processing and collectable on the basis of the image file, the image file is subjected to the predetermined image processing by using the pre-collection information thus added and then output, and when the pre-collection information is not beforehand added to the image file, the pre-collection information is collected on the basis of the image file, the image file is added with the pre-collection information thus collected and stored in the predetermined storage medium, and the image file is subjected to the predetermined image processing by using the pre-collection information and then output.

According to the first image processing method of the present invention, in a case where it is instructed to subject an image file to predetermined image processing, and when pre-collection information is added to the image file, the image file is subjected to the predetermined image processing by using the pre-collection information thus added and then output while when no pre-collection information is added to the image file, the pre-collection information is collected on the basis of the image file and added to the image file, and also the image file is subjected to the predetermined image processing by using the pre-collection information thus collected and then output. Accordingly, with respect to the image files which have been once subjected to the image processing, they are added with the pre-collection information, and they can be subjected to the next image processing by using the pre-collection information thus added. As a result, it is unnecessary to repetitively carry out the processing of collecting the pre-collection information, so that the processing time when the image file is subjected to the image processing can be shortened, and also the image processing can be more efficiently carried out.

The present invention is also directed to a second storage medium storing an image processing program for subjecting an image file to predetermined image processing and outputting the image file thus processed. In a case where it is instructed that predetermined image processing is carried out on a designated image file of image files stored in a predetermined storage medium, when the image file is beforehand added with pre-collection information that is used to carry out the predetermined image processing and collectable on the basis of the image file, the image processing program subjects the image file to the predetermined image processing by using the pre-collection information thus added and then outputs, and when the pre-collection information is not beforehand added to the image file, the image processing program collects the pre-collection information on the basis of the image file, adds the image file with the pre-collection information thus collected and stored in the predetermined storage medium, subjects the image file to the predetermined image processing by using the pre-collection information and then outputs the image file thus processed.

In the second storage medium of the present invention, by installing and starting an image processing program, in a case where it is instructed to carry out predetermined image processing on an image file, and if pre-collection information is added to the image file, the image file is subjected to the predetermined image processing by using the added pre-collection information and then output while no pre-collection information is added to the image file, the pre-collection image-information is collected on the basis of the image file and added to the image file, and also the image file is subjected to the predetermined image processing by using the pre-collection information thus collected and then output. Accordingly, the image files which have been once subjected to the image processing are added with pre-collection information, and they can be subjected to the next image processing by using the pre-collection information thus added. As a result, it is unnecessary to repetitively carry out the processing of collecting the pre-collection information, so that the processing time when the image files are subjected to the image processing can be shortened, and also the image processing can be more efficiently performed.

The present invention is also directed to a third image processing apparatus for subjecting an image to predetermined image correction processing. The third image processing apparatus includes: an image content judging module for extracting an object area contained in a designated image on the basis of pixel information of the image when an output instruction containing rotation of the designated image is made, and judging the image content of the image on the basis of the arrangement of the object area thus extracted with respect to the overall image; and an image correcting and rotating module for subjecting the designated image to predetermined image correction processing on the basis of the image content thus judged and rotating and outputting the image.

According to the third image processing apparatus of the present invention, when a designated image is rotated and output, an object area is extracted on the basis of pixel information of the image, an image content is identified in accordance with the arrangement of the extracted object area with respect to the overall image, and the image is subjected to predetermined image processing on the basis of the identified image content and output while being rotated. Accordingly, the identification of the image content based on the arrangement of the object area with respect to the overall image is carried out while using the image before the rotation, and thus the image content can be more properly identified. As a result, the image correction processing when the image is rotated and output can be more properly performed.

The third image processing apparatus of the present invention, wherein the image content judging module may be structured so as to extract an area comprising pixels of predetermined flesh color as the object area, and to judge on the basis of the arrangement of the object area with respect to the overall image whether the image content of the image is the image of a character. Accordingly, identification of a character image based on the arrangement of the object area constructed by the pixels of predetermined flesh color with respect to the overall image can be more properly performed.

In the third image processing apparatus of the present invention, the image content judging module may be structured so as to judge whether the image content of the image is the image of a character on the basis of a condition that a contact amount by which the extracted object area comes into contact with the upper side and the right and left sides of the image is not more than the predetermined amount. Here, a value of 0 is contained in the “predetermined value.” That is, the image content of the image may be identified as a character image on the basis of a condition that the extracted object area does not come into contact with the upper side and right and left sides of the image.

Further, in the third image processing apparatus of the present invention, the image content judging module may be structured to judge whether the image content of the image is the image of a character on the basis of a condition that laterally arranged areas corresponding to both the eyes of a character and an area that is located below the areas and corresponds to the mouth of the character exist. Accordingly, the character image based on the existence of the area corresponding to both the eyes or mouth can be more properly identified.

In the third image processing apparatus of the invention, when the image content of the image is not judged as the image of a character, the image content judging module may judge that the image content of the image is the image of a scene.

In the third image processing apparatus of the present invention, when the image content of the image is the image of a scene, the image correcting and rotating module may subject the image to sky blue correction processing of correcting the predetermined sky blue on the basis of a condition that pixels of predetermined sky blue do not come into contact with the lower side of the image. Accordingly, sky blue correction processing based on the arrangement of pixels of a predetermined sky blue can be more properly performed.

Further, in the third image processing apparatus of the present invention, the image may be compressed in a predetermined format, the image processing apparatus may be equipped with a data storage module for storing data, and an information calculating and obtaining module for sequentially restoring the designated image from the head thereof until at least the pixel information can be obtained, the pixel information thus obtained is stored in the data storage module, and starting point restoring information for restoring the image with a predetermined position of the image as a starting point is obtained and stored in the data storage module. The image content judging module extracts an object area contained in the image on the basis of the pixel information stored in the data storage module, and the image correcting and rotating module restores the image with the predetermined position as a starting point on the basis of the starting point restoring information stored in the data storage module to sequentially generate a post-rotation image from the upper end, and subjects the post-rotation image to the predetermined image correction processing. Accordingly, when an image after rotation of a compressed image is sequentially generated from the upper end thereof by using a starting point restoring information and then output, the image content can be more properly identified, and the image correction processing can be carried out.

The present invention is also directed to a second image processing method for subjecting an image to predetermined image correction processing and outputting the image. The second image processing method including the steps of: (a) extracting an object area contained in a designated image on the basis of pixel information of the image when an output instruction containing rotation of the designated image is made, and judging the image content of the image on the basis of an arrangement of the extracted object area with respect to the whole image; and (b) subjecting the designated image to the predetermined image correction processing on the basis of the judged image content, and rotating and outputting the image.

According to the second image processing method of the present invention, when a designated image is rotated and output, an object area is extracted on the basis of pixel information of the image, the content of the image are identified in accordance with the arrangement of the extracted object area with respect to the overall image, predetermined image processing is carried out on the basis of the image content thus identified, and then the image is rotated and output. Accordingly, the identification of the image content based on the arrangement of the object area with respect to the overall image is carried out while using the image before the rotation thereof, so that the image content can be more properly identified. As a result, the image correction processing when the image is rotated and output can be more properly carried out.

The present invention is also directed to a third recording medium storing an image processing program for subjecting an image to predetermined image processing and outputting the image. The image processing program includes: an image content judging module for extracting an object area contained in a designated image on the basis of pixel information of the image and judging the image content of the image when an output instruction containing rotation of the designated image is made on the basis of an arrangement of the extracted object area with respect to the whole image; and an image correcting and rotating module for subjecting the designated image to the predetermined image correction processing on the basis of the judged image content, and rotating and outputting the image.

According to the third storage medium of the present invention, by installing and starting an image processing program, when a designated image is rotated and output, an object area is extracted on the basis of pixel information of the image, the content of the image is identified in accordance with the arrangement of the extracted object area with respect to the overall image, predetermined image processing is carried out on the basis of the image content thus identified, and then the image is rotated and output. Accordingly, the identification of the image content based on the arrangement of the object area with respect to the overall image is carried out while using the image before the rotation thereof, so that the image content can be more properly identified. As a result, the image correction processing when the image is rotated and output can be more properly carried out.

### BRIEF DESCRIPTION OF THE DRAWINGS

FIG. 1 is a diagram showing the construction of a printer 20 according to a first embodiment;

FIG. 2 is a flowchart showing an example of image rotating and printing processing of the first embodiment;

FIG. 3 is a diagram showing an example of a pre-collection information managing table of the first embodiment;

FIG. 4 is a flowchart showing an example of pre-collection information obtaining processing of the first embodiment;

FIG. 5 is a diagram showing the relationship between a block of an image file and an access unit according to the first embodiment;

FIG. 6 is a diagram showing an example of a starting point of the first embodiment;

FIG. 7 is a diagram showing the concept of decoding intermediate information of the first embodiment;

FIG. 8 is a diagram showing an example of starting point restoring information of the first embodiment;

FIG. 9 is a diagram showing the concept of each area of a data buffer 24 of the first embodiment;

FIG. 10 is a diagram showing an aspect that the pre-collection information managing table of the first embodiment is updated;

FIG. 11 is a diagram showing an example of an aspect that the starting point restoring information of the first embodiment is updated;

FIG. 12 is a diagram showing an aspect that the processing of steps S140 to S220 is executed;

FIG. 13 is a diagram showing an aspect that accumulated blocks after the rotation according to the first embodiment is set as a band unit;

FIG. 14 is a diagram showing an example of a starting point block according to a modification;

FIG. 15 is a flowchart showing an example of image rotating and printing processing of a second embodiment;

FIG. 16 is a diagram showing an example of the structure of an image file added with starting point restoring information of the second embodiment;

FIG. 17 is a flowchart showing an example of starting point restoring information obtaining processing of the second embodiment;

FIG. 18 is a flowchart showing an example of automatic correcting and printing processing of a third embodiment;

FIG. 19 is a diagram showing a file structure added with an automatic correction processing parameter of the third embodiment;

FIG. 20 is a flowchart showing an example of correcting parameter obtaining processing of the third embodiment;

FIG. 21 is a flowchart showing an example of image rotating and printing processing of a fourth embodiment;

FIG. 22 is a flowchart showing an example of object recognition processing of the fourth embodiment;

FIG. 23 is an illustration showing an example of a flesh color area of the fourth embodiment;

FIG. 24 is an illustration showing an example of a pixel area corresponding to both the eyes or mouth of the fourth embodiment; and

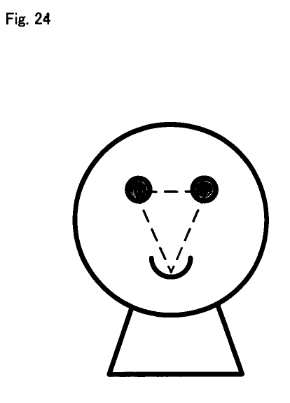

FIG. 25 is an illustration showing an example of a sky blue area of a landscape image of the fourth embodiment.

### DESCRIPTION OF THE PREFERRED EMBODIMENTS

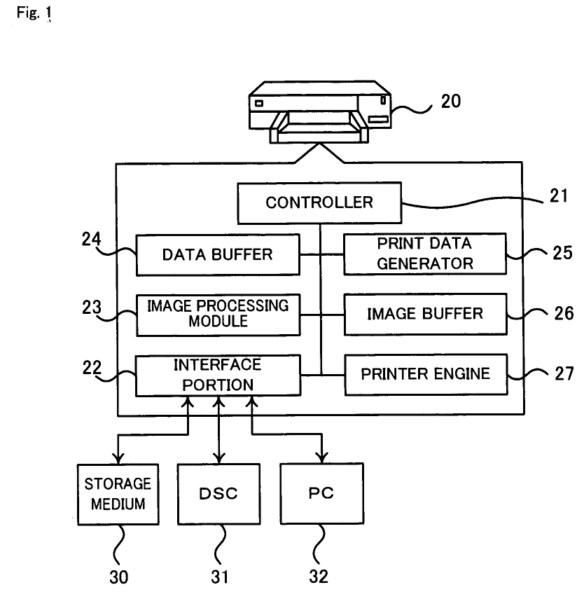

Next, preferred embodiments for carrying out the present invention will be described. FIG. 1 is a diagram showing the construction of a printer 20 containing an image processing apparatus as a first embodiment of the present invention. As shown in FIG. 1, the printer 20 of the first embodiment is constructed as an ink jet printer that comprises a controller 21 for controlling the overall apparatus, an interface portion 22 to be connected to a detachable storage medium 30 such as a memory card or the like, a digital still camera 31, a personal computer 32, etc., an image processing module 23 for carrying out various kinds of image processing on an image file read out from the storage medium 30, a data buffer 24 for temporarily storing data, a print data generator 25 for subjecting the read-in image file to color conversion processing and binarizing processing, etc., to generate print data, an image buffer 26 for accumulating the print data thus generated, and a printer engine 27 for executing printing on the basis of the print data accumulated in the image buffer 26, and jets ink of each color onto a sheet to carry out the printing. In the image processing module 23, the processing of restoring an image file which is stored in the storage medium 30 or the like and compressed in the JPEG format is carried out. The image file of the JPEG format is subjected to steps such as block division, discrete cosine transformation (hereinafter referred to as DCT), quantization processing, Huffman coding, etc., to be compressed. The image file of the JPEG format thus processed is a general image file and does not constitute a main part of the present invention, and thus a detailed description thereof is omitted.

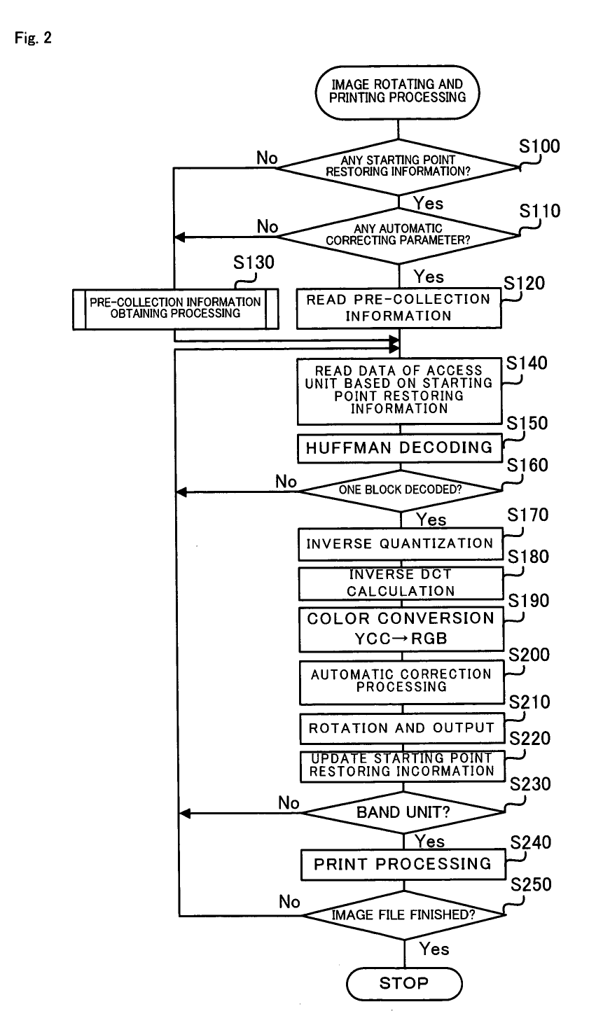

Next, the operation of the printer 20 thus constructed, particularly, the operation when automatic correction processing or rotation processing is carried out on an image file from the storage medium 30 or the like and then printing is carried out will be described. FIG. 2 is a flowchart showing an example of image rotating and printing processing executed by the controller 21, the image processing module 23, the print data generator 25, etc., when a print instruction containing the automatic correction processing and the rotation processing is carried out. As a case where such a print instruction is made, for example, a case may be considered where an instruction for carrying out the automatic correction processing via an operation panel (not shown) or the like of the printer 20 is made or a case where a printing layout requiring the rotation processing is set and printing is instructed. Furthermore, in the first embodiment, a case where an image file is rotated clockwise by 90° will be described as a specific example.

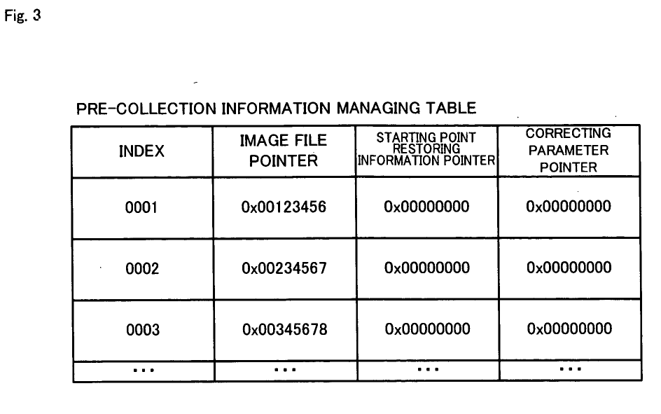

In the image rotating and printing processing, it is first judged whether an automatic correction processing parameter used for automatic correction processing of an image file associated with a print instruction or starting point restoring information used for the processing of sequentially generating an image after rotation from the upper end thereof exists as pre-collection information corresponding to the image file in a pre-collection information storage area of the data buffer 24 as shown in the figure (step S100, S110). It is assumed in the first embodiment that the presence or absence of the pre-collection information is judged by using the pre-collection information managing table shown in FIG. 3 which is stored in the data buffer 24. The pre-collection information managing table is constructed as shown in the figure so as to manage an index for identifying each image file stored in the storage medium 30 or the like, an image file pointer for indicating the physical position of the image file on the storage medium 30, a starting point restoring information pointer for indicating the physical position of the starting point restoring pieces of information on the data buffer 24, and a correcting parameter pointer for indicating the physical position of the automatic correction processing parameter on the data buffer 24. With respect to the index and the image file pointer out of these pieces of information, indexes are allocated to all the image files stored in the storage medium 30 or the like and image file pointers are obtained and registered when the printer 20 is powered on or the storage medium 30 or the like is loaded. With respect to the starting point restoring information pointer and the correcting parameter pointer, an empty value (Null value) is set when the printer 20 is powered on or the storage medium 30 or the like is loaded. This is based on the fact that the pre-collection information of the data buffer 24 is cleared when the printer 20 is powered off or the storage medium 30 or the like is loaded/detached. Accordingly, when the printer 20 is powered on or the storage medium 30 or the like is loaded to first print an image file, with respect to all the image files, the corresponding pre-collection information does not exist. The processing of updating the starting point restoring information pointer or the correcting parameter pointer will be described later.

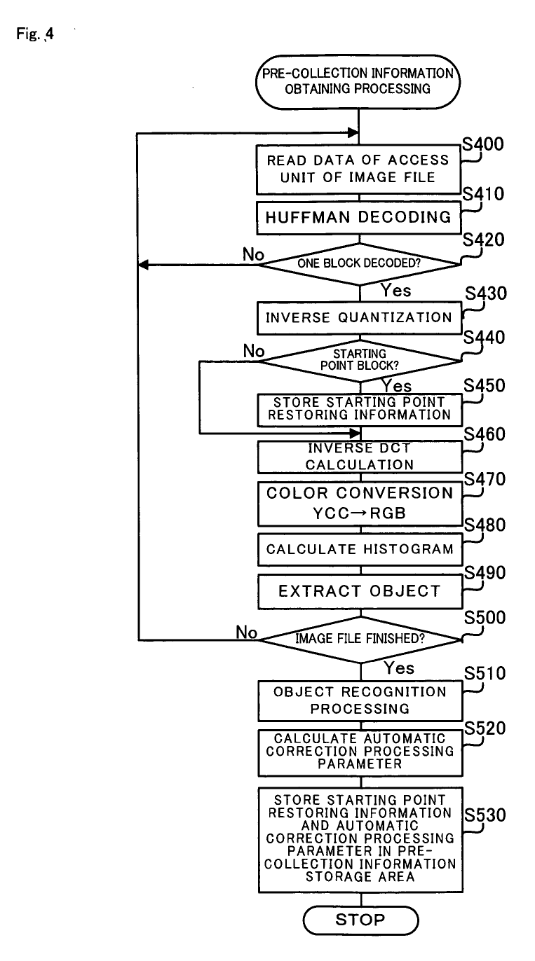

When both the starting point restoring information and the automatic correction processing parameter exist in the data buffer 24, the starting point restoring information and the automatic correction processing parameter which are specified by the starting point restoring information pointer and the correcting parameter pointer in the pre-collection information managing table are read out from the pre-collection information storing area of the data buffer 24, and copied to a working area of the data buffer 24 (step S120). When neither the starting point restoring information nor the automatic correction processing parameter exists, pre-collection information obtaining processing to obtain the starting restoring information and the automatic correction processing parameter is executed (step S130). Here, the description of the image rotating and printing processing is interrupted and the pre-collection information obtaining processing shown in FIG. 4 will be described.

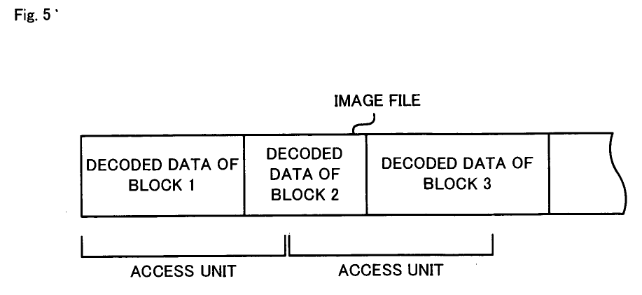

In the pre-collection information obtaining processing, data of one access unit of an image file associated with a print instruction are read in from the storage medium 30 or the like (step S400), and Huffman decoding processing is carried out on the read-in data (step s410). Here, the access unit is a read-in unit predetermined in accordance with the specification of the storage medium 30 or the like, and it corresponds to a sector or the like in a flash memory. As shown in FIG. 5, the data size of each block of the image file compressed in the data size of each block of an image file coded in the JPEG format is not necessarily coincident with the access unit, and the data size is different among the respective blocks. Therefore, the data of one block may extend over a plurality of access units.

Data based on the access unit is read in until the data of one block are Huffman-decoded, and Huffman decoding processing is repetitively carried out. When the data of one block is decoded (step S420), inverse quantization processing is carried out on the decoded data (quantized DCT coefficient of block) (step S430). By executing the inverse quantization processing, the DCT coefficient of the block is obtained. Here, in the image file of the JPEG format, with respect to the quantized DC component of the quantized DCT coefficient, the differential value between blocks is subjected to Huffman coding. Therefore, the quantized DC component is obtained by accumulating the differential value of the quantized DC component obtained by Huffman decoding, and the inverse quantization processing is carried out on the quantized DC component to obtain the DC component.

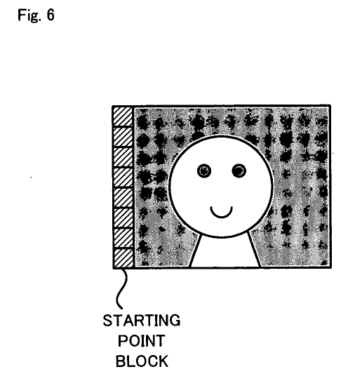

Subsequently, it is judged whether the present block is a starting point block or not (step S440). Here, the starting point block is a block serving as a starting point to restore an image file from some midway point thereof. In the first embodiment, a left-end block located at the upper end when the image is rotated clockwise by 90° is set as a starting point block (see FIG. 6).

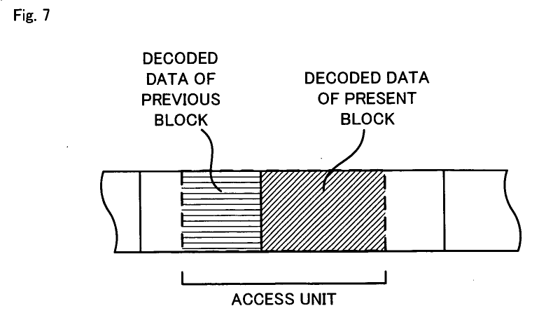

When the present block is a starting point block, the starting point restoring information for restoring the image file with the block set as a starting point is stored in a working area of the data buffer 24 (step S450). The starting point restoring information is specifically constructed by a file pointer for indicating the access-unit based physical position from which the data of the starting point block is started, decoding intermediate information for Huffman-decoding the data of the starting point block from the access unit and the DC component of the starting point block. FIG. 7 is a diagram showing the concept of the decoding intermediate information. As described above, the data size of each block and the access unit are not necessarily coincident with each other, and the data size is different among the blocks, so that the access unit in which the data of the starting point block is started contains the data of the preceding block. Accordingly, in order to Huffman-decode the data of the starting point block, information concerning Huffman decoding of the data of the preceding block (for example, Huffman-decoded bit number as data of the preceding data, etc.,) is needed, and the information as described above corresponds to the decoding intermediate information.

Subsequently, the inverse DCT calculation processing is carried out on the DCT coefficient obtained by the inverse quantization processing of the step S430 to obtain the pixel information of the block (step S460), and the color conversion processing for converting the color space of the pixel information thus obtained is executed (step S470). Here, the color conversion processing is the processing of converting the YCC color space used in the image file of the JPEG format to the RGB color space.

When the pixel information converted to the RGB color space is obtained, a histogram representing a distribution of RGB values of the overall image file is accumulated and stored in the working area of the data buffer 24 (step S480). Target pixels for which the histogram is accumulated may be set to pixels sampled by an appropriate rule.

Subsequently, an object area such as the face of a character or the like is extracted from the pixels of the present block and stored in the working area of the data buffer 24 (step S490). In the first embodiment, the extraction of the object area is based on extraction of a flesh color area comprising the pixels of flesh color out of the pixels of the present block. The extraction of the flesh color area is carried out by presetting the range of the RGB values corresponding to the flesh color and extracting the pixels in the range of the RGB values.

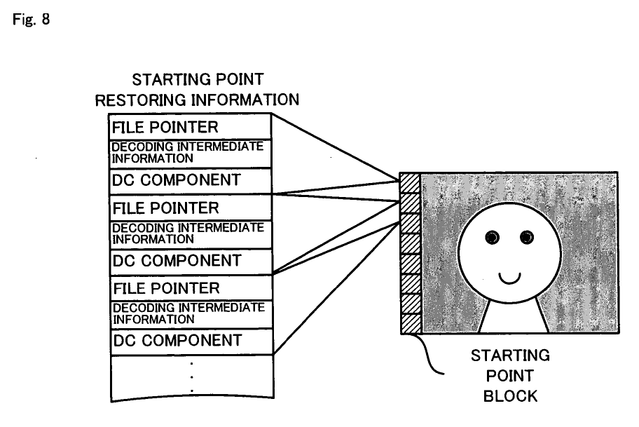

When the present block is not the last block of the image file, the processing returns to step S400 (step S500), and the processing of the steps S400 to S490 is repetitively carried out on the next block. FIG. 8 is a diagram showing an example of the starting point restoring information when the processing of the steps S400 to S490 is repetitively carried out. As shown in FIG. 8, in the first embodiment, the left-end block of the image is set as the starting point block, and thus the starting point restoring information for the left-end block (the file pointer, the decoding intermediate information and the DC component) is sequentially stored from the upper block. By sequentially restoring the image file from the head thereof as described above, the starting point restoring information and the histogram of the RGB values are obtained and also the object area is extracted, and these are stored in the working area of the data buffer 24.

When the processing of the steps S400 to S490 is repetitively carried out until the last block of the image file as described above, the object recognition processing of judging on the basis of the object area extracted in step S490 whether the image content is a character image or a scene image is then executed (step S510). Various kinds of rules can be applied to the object recognition processing, and in the first embodiment, the judgment of the character image or the scene image is carried out on the basis of the arrangement of the object area with respect to the overall image (for example, whether the object area comes into contact with the upper side or the right and left sides) or whether the pixel area corresponding to both the eyes or mouth exist in the object area.

When the image content is identified by the object recognition processing as described above, the automatic correction processing parameter for subjecting the image file to the automatic correction processing is calculated on the basis of the image content thus identified and the histogram of the RGB values, and stored in the working area of the data buffer 24 (step S520). The calculation of the automatic correction processing parameter can be carried out by applying various kinds of rules. In the first embodiment, when the image content is a character image, parameters are calculated so as to carry out flesh color correction processing for carrying out correction so that the flesh color is more excellent, soft focus processing, or brightness correction processing of correcting the brightness so that the brightness is slightly higher. When the image content is a scene image, parameters are calculated so as to carry out tender green color correction processing for carrying out correction so that tender green color is more excellent, or color saturation correction processing for carrying out correction so that color saturation is more vivid, etc. Parameters are also calculated so as to carry out various kinds of image correction processing (contrast correction processing, y correction processing, etc.,) in accordance with the histogram of the RGB values irrespective of whether the image content is a character image or a scene image.

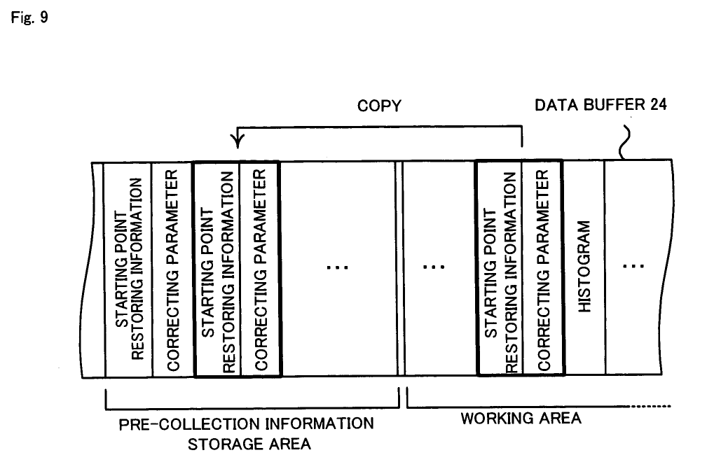

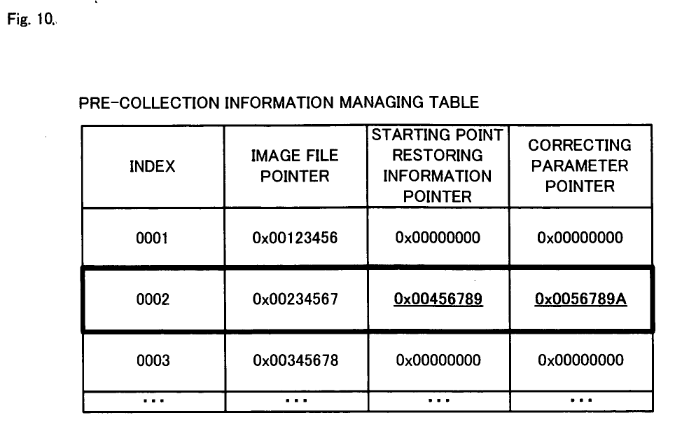

The starting point restoring information stored in the working area of the data buffer 24 and the automatic correction processing parameter are copied into the pre-collection information storage area and also reflected to the pre-collection information managing table (step S530), and then the pre-collection information obtaining processing is finished. FIG. 9 is a diagram showing the concept of the working area of the data buffer 24 and the pre-collection information storage area. As shown in FIG. 9, various kinds of data obtained by executing the pre-collection information obtaining processing described above are stored in the working area of the data buffer 24, and the starting point restoring information and the automatic correction processing parameter out of these pieces of information are copied into the pre-collection information storage area. FIG. 10 is a diagram showing an example of the aspect that the pre-collection information managing table is updated. In this example, the pre-collection information obtaining processing is executed on the image file of the index “002”, and the respective pointers indicating the physical positions of the starting point restoring information and the automatic correction processing parameter copied in the pre-collection information storage area are registered as a starting point restoring information pointer and a correcting parameter pointer.

When the starting restoring information and the automatic correction processing parameter as the pre-collection information are obtained by executing the pre-collection information obtaining processing or reading the data from the pre-collection information storage area as described above, in the image rotating and printing processing, the file pointer of the first starting point block out of the starting point restoring information thus obtained is subsequently read in, and the data of the access unit specified by the read-in file pointer is read out from the storage medium 30 or the like and subjected to Huffman decoding (steps S140, S150). At this time, by using the decoding intermediate information of the starting point restoring information, the data of the starting point block out of the data of the access unit can be decoded.

When the data of one block is decoded (step S160), the inverse quantization processing, the inverse DCT calculation processing and the color conversion processing are executed (steps S170 to S190). Here, when the DC component of the DCT coefficient is obtained, the DC component of the starting point restoring information is read in.

Subsequently, the automatic correction processing is executed on the block according to the automatic correction processing parameter obtained as the pre-collection information (step S200). Specifically, the processing of converting the pixel information is carried out by using a lookup table serving as a conversion table of the pixel information generated on the basis of the automatic correction processing parameter.

Subsequently, the block is clockwise rotated by 90°, and then output to the working area of the data buffer (step S210). When the block is output to the data buffer 24, the block itself is rotated, and output so that the position of the block is set to the position after the rotation (for example, the block at the upper left corner is located at the upper right corner).

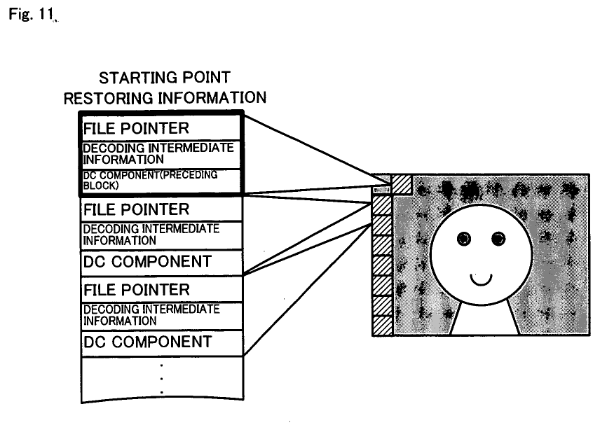

When the block is rotated and output as described above, the starting point restoring information of the block is updated to the starting restoring information of the next block (the adjacent block located at the right side of the block) (step S220). That is, it is updated to the file pointer of the access unit at which the data of the next block is started, the decoding intermediate information and the DC component (see FIG. 11). Here, with respect to the DC component, and the quantized DC component of the present block is stored. Accordingly, when the next block is restored, the quantized DC component and the differential value obtained through Huffman decoding of the data of the next block are accumulated to obtain the quantized DC component of the next block. Here, when the starting point restoring information is updated, the starting point restoring information stored in the working area of the data buffer 24 is updated. That is, with respect to the starting point restoring information stored in the pre-collection information storage area of the data buffer 24, the information concerning the block at the left end as the starting point block is held without change.

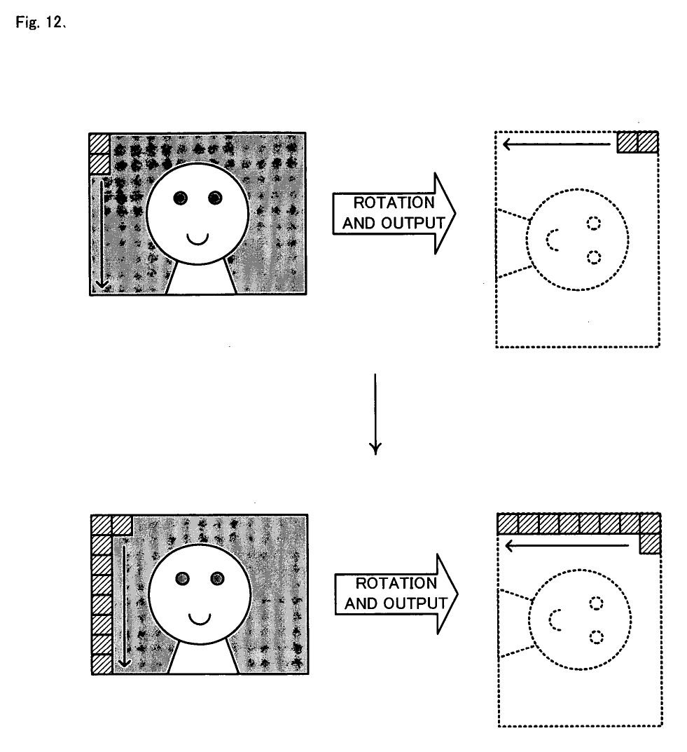

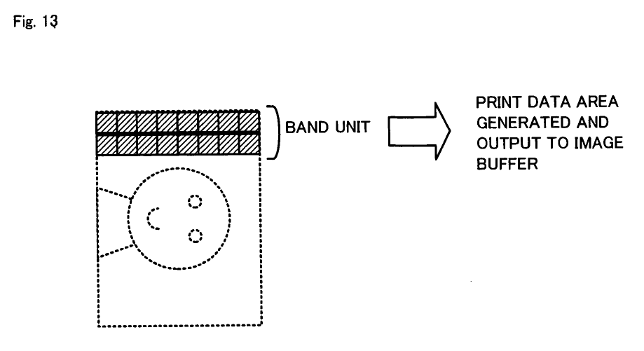

The processing of the steps S140 to S220 is repetitively carried out until post-rotation blocks output to the working area of the data buffer 24 are accumulated and the accumulation result reaches a band unit corresponding to a unit to be printed by the printer engine 27 (step S230). FIG. 12 is a diagram showing an aspect that the processing of the steps S140 to S220 is repetitively carried out. As shown in FIG. 12, the processing of the steps S140 to S220 is sequentially carried out on each block at the left side as a starting point block from the upper end blocks, thereby outputting the blocks at the upper end of the post-rotation image. When the processing to be carried out on the blocks at the left end is finished, the processing of the steps S140 to S220 is repetitively carried out on blocks on the column located at the right side of the left-end blocks. When the accumulated post-rotation blocks reach a band unit as shown in FIG. 13, print data is generated on the basis of the data of the band unit by the print data generator 25, and output to the image buffer 26. The printer engine 27 carries out printing on the basis of the print data (step S240). Then, when this processing reaches the last block of the image file (step S250), the image rotating and printing processing is finished.

According to the printer 20 of the first embodiment, the starting point restoring information and the automatic correction processing parameter are stored as the pre-collection information in the pre-collection information storage area of the data buffer 24 in association with the image file. In the case where a print instruction containing the automatic correction processing and the rotation processing is made, when the pre-collection information corresponding to the image file connected to the print instruction does not exist, the pre-collection information obtaining processing is executed to obtain the pre-collection information and store it into the pre-collection information storage area of the data buffer 24 while when the pre-collection information corresponding to the image file exists, the pre-collection information is read from the pre-collection information storage area of the data buffer 24, and the image file can be subjected to the automatic correction processing and the rotation processing by using the pre-collection information thus obtained and printed. Accordingly, the pre-collection information is stored in the data buffer 24 in association with the image file, and thus the image file for which the pre-collection information has been once obtained can be subjected to the automatic correction processing or the rotation processing at the next time by using the pre-collection information. As a result, it is unnecessary to repetitively carry out the processing of obtaining the pre-collection information (pre-collection information obtaining processing), so that the processing time when the image processing is carried out on the image file can be shortened and the image processing can be more efficiently performed.

According to the printer 20 of the first embodiment, the association between the pre-collection information and the image file can be managed by using the pre-collection information managing table. Furthermore, the pre-collection information managing table is used to manage the image file pointer indicating the physical position of the image file on the storage medium 30, the starting point restoring information pointer indicating the physical position of the starting point restoring information on the data buffer 24, and the correcting parameter pointer indicating the physical position of the automatic correction processing parameter on the data buffer 24, so that the access speed to the image file, the starting point restoring information and the automatic correction processing parameter can be enhanced.

Here, in the printer 20 of the first embodiment, the data buffer 24 corresponds to the information storage module, the controller 21 and the image processing module 23 which execute the processing of the steps S100 to S230 of the image rotating and printing processing correspond to the image processing module, the controller 21, the print data generator 25 and the printer engine 27 which execute the processing of the step S240 of the image rotating and printing processing correspond to the print executing module, the storage medium 30 or the like corresponds to the predetermined storage medium, and the controller 21 and the image processing module 23 which execute the processing of clearing the pre-collection information from the pre-collection information storage area of the data buffer 24 corresponds to the information clear module. Furthermore, the pre-collection information managing table corresponds to the corresponding relationship managing table, the image file pointer corresponds to the address information of the image file, and the starting point restoring information pointer and the correcting parameter pointer correspond to the address information of the pre-collection information.

In the printer 20 of the first embodiment, the pre-collection information of the data buffer 24 is cleared when the power is turned off or when the storage medium 30 is loaded/detached. However, the pre-collection information may be cleared at other timings.

In the printer 20 of the first embodiment, the pre-collection information is stored in the pre-collection information storage area of the data buffer 24. However, the pre-collection information may be stored in a memory other than the data buffer 24. For example, a non-volatile memory such as a flash memory or the like may be equipped to store the pre-collection information or the pre-collection information managing table in the non-volatile memory. With this construction, the pre-collection information can be prevented from being cleared when the printer 20 is powered off.

In the printer 20 of the first embodiment, the association between the pre-collection information and the image file is managed by using the pre-collection information managing table. However, it is sufficient to store the pre-collection information in association with the image file, and thus the association between the pre-collection information and the image file may be managed by other methods.

In the printer 20 of the first embodiment, the image file is identified by using the index and the image file pointer in the pre-collection information managing table. However, it is sufficient to identify the image file, and thus the file name or the like of the image file may be used. Likewise, the starting point restoring information pointer and the correcting parameter pointer are used. It is sufficient to identify the starting point restoring information and the automatic correction processing parameter, and other information may be used.

In the printer 20 of the first embodiment, the automatic correction processing parameter is exemplified as the pre-collection information used for the automatic correction processing, however, other information may be used as the pre-collection information. For example, the pixel information converted to the RGB color space, the histogram of the RGB values, and a lookup table generated on the basis of the automatic correction processing parameter may be used as the pre-collection information.

In the printer 20 of the first embodiment, when any one of the starting point restoring information and the automatic correction processing parameter does not exit, the pre-collection information obtaining processing is executed although any one of them exists. However, when any one of them exists, the pre-collection information obtaining processing may be executed by skipping the starting point restoring information obtaining processing (steps S440 to S450) and the automatic correction processing parameter calculating processing (steps S460 to S490, S510, S520).

In the printer 20 of the first embodiment, the starting point restoring information and the automatic correction processing parameter are stored as the pre-collection information, and used for the rotation processing and the automatic correction processing. However, only the starting point restoring information may be stored or only the automatic correction processing parameter may be stored. Furthermore, the information used for image processing other than the rotation processing and the automatic correction processing may be stored as the pre-collection information and used for the next image processing.

In the printer 20 of the first embodiment, the image file compressed in the JPEG format has been described. It is a matter of course that this embodiment is applicable to an image file compressed in another format. In this case, information necessary to restore the image file from a predetermined position (for example, the pixels at the left end) may be stored as starting point restoring information in accordance with the compression format.

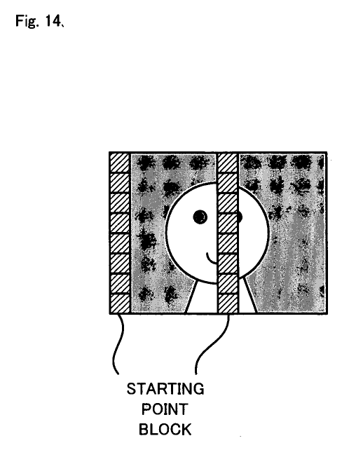

In the printer 20 of the first embodiment, the case where the clockwise rotation is made by 90° has been described as a specific example. However, the present invention is not limited to this case. For example when the rotation is made by 180°, the blocks at the left end as the starting point blocks are sequentially restored from the lower side, whereby the post-rotation blocks of the image can be sequentially output from the upper end block. Furthermore, in the case of the counterclockwise rotation of 90°, as shown in FIG. 14, the blocks on a column located substantially at the center of the image file are set as starting point blocks in addition to the blocks at the left end, and the upper half of the post-rotation image is restored with the starting point blocks on the column located substantially at the center as the starting points while the lower half of the post-rotation image is restored with the starting point blocks at the left end as starting points. In this case, since the starting point information varies in accordance with the direction or angle of the rotation, the starting point restoring information as the pre-collection information may be managed in association with the combination of the image file and the rotation pattern (direction and angle). Likewise, when the automatic correction processing parameter varies in accordance with the processing pattern of the automatic correction processing, the automatic correction parameter as the pre-collection information may be managed in association with the combination of the image file and the processing pattern. With this construction, the present invention can be adapted to a case where the pre-collection information is associated with the combination of the image file and the processing pattern (that is, the pre-collection information varies in accordance with the processing pattern).

In the first embodiment, the present invention has been described in the form of the printer 20 in which the pre-collection information is stored in the data buffer 24 in association with the image file. However, the present invention may be designed in the form of an image processing apparatus for carrying out the image processing as described above. Furthermore, it may be applicable in the form of a control method for the image processing apparatus as described above or in the form of a program for the image processing apparatus.

Next, a second embodiment of the present invention will be described. A printer 20B of the second embodiment has the same hardware construction as the printer 20 of the first embodiment shown in FIG. 1. In order to avoid overlapping description, the hardware construction of the printer 20B of the second embodiment is represented by the same reference numerals as the hardware construction of the printer 20 of the first embodiment, and the description thereof is omitted.

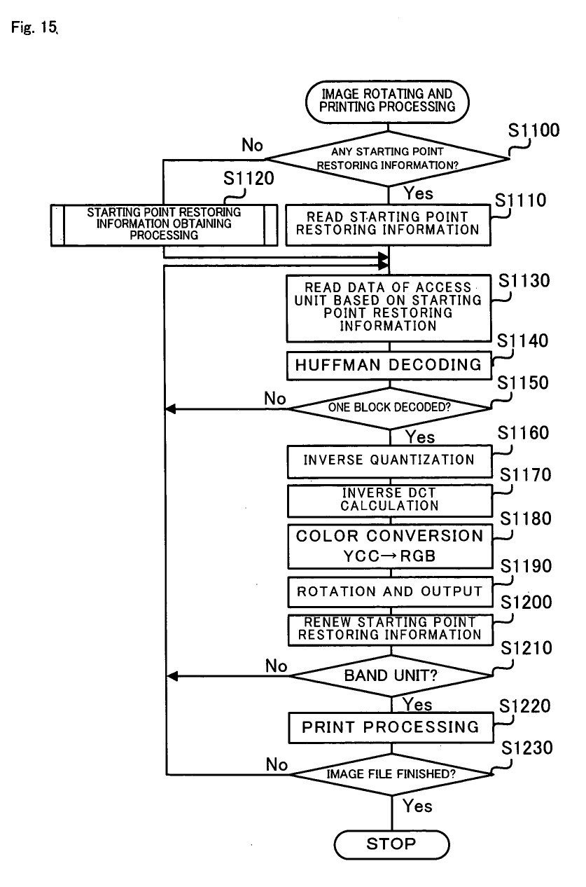

Next, the operation of the printer 20B of the second embodiment thus constructed, particularly the operation when the image file read out from the storage medium 30 or the like is rotated and printed will be described. FIG. 15 is a f low chart showing an example of the image rotating and printing processing executed by the controller 21, the image processing module 23, the print data generator 25, etc., when a print instruction containing rotation of an image file is made. As a case where such a print instruction is made, for example, a case may be considered where a print instruction is made by setting a printing layout requiring rotation of an image file via an operating panel (not shown) or the like of the printer 20B for example. Furthermore, in the second embodiment, a case where an image file is clockwise rotated by 90° will be described as a specific example.

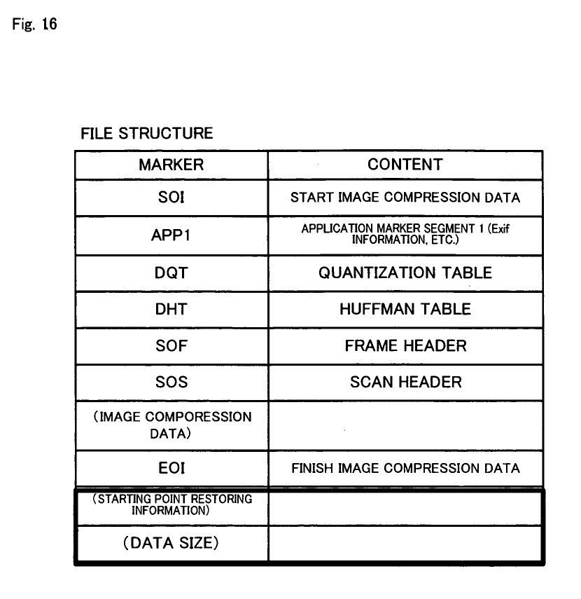

In the image rotating and printing processing, as shown in the figure, it is first judged whether the image file associated with the print instruction is added with starting point restoring information used for sequentially processing generation of a post-rotation image from the upper end (step S1100). FIG. 16 is a diagram showing an example of the file structure of the image file of the JPEG format added with the starting point restoring information. As shown in FIG. 16, the image file of the JPEG format comprises a plurality of marker segments, and the marker segments contain SOI for indicating the head of compressed data of an image, APP1 for storing Exif information, etc., as an application marker segment, DQT for defining the quantized table, DHT for defining the Huffman table, SOF for indicating various kinds of parameters concerning a frame, SOS for indicating various kinds of parameters concerning scan, EOI for indicating the end of the compressed data of the image, etc., and the compressed data of the image is stored just before the marker segment EOI. In the second embodiment, the starting point restoring information and the data size of the starting point restoring information are stored just after the marker segment EOI. The details of the starting point restoring information and the processing of storing the starting point restoring information will be described later. Accordingly, in step S1100, by judging whether data exists just after the marker segment EOI or not, it is judged whether the starting point restoring information is added.

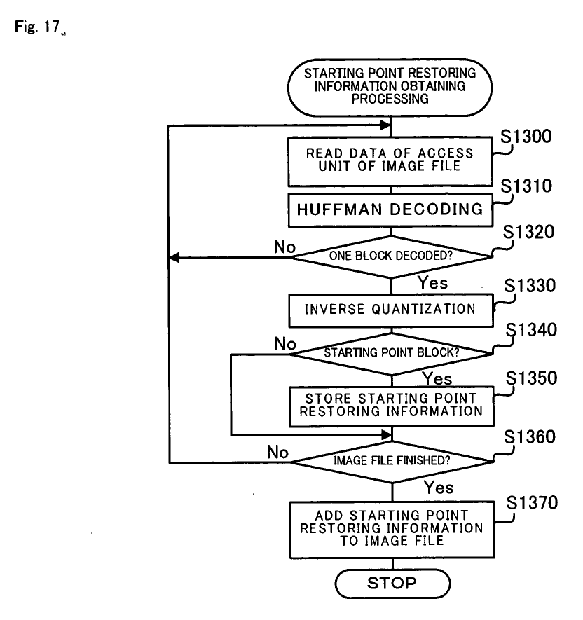

When the starting point restoring information is added to the image file, the starting point restoring information is read out from the image file and copied into the data buffer 24 (step S1110). When no starting point restoring information is added to the image file, the starting point restoring information obtaining processing to obtain the starting point restoring information is executed (step S1120). Here, the description of the image rotating and printing processing is interrupted, and the starting point restoring information obtaining processing shown in FIG. 17 will be described.

In the starting point restoring information obtaining processing, as shown in FIG. 17, the data of one access unit of the image file associated with the print instruction is read out from the storage medium or the like (step S1300), and the processing of subjecting the read-in data to Huffman decoding (step S1310) is executed. Here, the access unit is a read-in unit of data which is predetermined in accordance with the specification of the storage medium 30 or the like, and for example, it corresponds to a sector or the like in a flash memory. Furthermore, as shown in FIG. 5, the data size of each block of the image file compressed by the JPEG format is not necessarily coincident with the access unit, and the data size is different among blocks, so that data of one block may extend over a plurality of access units.

The access-unit data are read in until the data of one block has been subjected to Huffman decoding, and Huffman decoding processing is repetitively executed. When the data of one block has been decoded (step S1320), the inverse quantization processing is carried out on the decoded data (the quantized DCT coefficient of the block) (step S1330). By executing the inverse quantization processing, the DCT coefficient of the block is obtained. Here, in the image file of the JPEG format, with respect to the quantized DC component of the quantized DCT coefficient, the differential value between blocks is subjected to Huffman decoding. Therefore, the quantized DC component is obtained by accumulating the differential value of the quantized DC component obtained by Huffman decoding, and the DC component is obtained by subjecting the quantized DC component to the inverse quantization processing.

Subsequently, it is judged whether the present block is a starting point block or not (step S1340). Here, the starting block is a block serving as a starting point to restore the image file from some midway point thereof, and in the second embodiment, the block at the left end which is located at the upper end when the image is clockwise rotated by 90° is set as a starting block (see FIG. 6).

When the present block is a starting block, the starting point restoring information for restoring the image file with the block as a starting point is stored in the data buffer 24 (step S1350). The starting point restoring information specifically comprises a file pointer for indicating the physical position of the access unit at which the data of the starting point block is started, decoding intermediate information for carrying out Huffman decoding on the data of the starting point block from the access unit, and the DC component of the starting point block. As described above, FIG. 7 is a diagram showing the concept of the decoded intermediate information. As described above, the data size of each block and the access unit are not necessarily coincident with each other, and the data size is different among blocks, so that the access unit at which the data of the starting point block is started contains the data of the preceding block. Accordingly, in order to subject the data of the starting point block to Huffman decoding, information concerning Huffman decoding of the data of the preceding block (for example, the bit number which was subjected to Huffman decoding as data of the preceding data) is required, and such information corresponds to the decoding intermediate information.

When the present block is not the last block of the image file, the processing returns to step S1300 (step S1360), and the processing of the steps S1300 to S1350 is repetitively carried out on the next block. As described above, FIG. 8 is a diagram showing an example of the starting point restoring information when the processing of the steps S400 to S490 is repetitively carried out. As shown in FIG. 8, in the second embodiment, the left-end block of the image is set as the starting point block, and thus the starting point restoring information for the left-end block (the file pointer, the decoding intermediate information and the DC component) is sequentially stored from the upper block. By sequentially restoring the image file from the head thereof as described above, the starting point restoring information is obtained and stored in the working area of the data buffer 24.

When the processing of steps S1300 to S1350 is repetitively carried out until the last block of the image file, the starting point restoring information stored in the data buffer 24 is added to the image file (step S1370), and then the starting point restoring information obtaining processing is finished. When the starting point restoring information is added to the image file, the starting point restoring information and the data size are stored at the last portion of the image file (just after the marker segment EOI).

When the starting point restoring information obtaining processing is executed or the starting point restoring information added to the image file in advance is read in, in the image rotating and printing processing, the file pointer of the first starting point block out of the starting point restoring information thus obtained is read in, and the data of the access unit specified by the read-in file pointer is read out from the storage medium 30 or the like and then subjected to Huffman decoding (steps S1130, S1140). At this time, by using the decoding intermediate information of the starting point restoring information, the data of the starting point block out of the data of the access unit can be decoded.

When the data of one block is decoded (step S1150), the DCT coefficient is obtained by the inverse quantization processing (step S1160), and the DCT coefficient thus obtained is subjected to inverse DCT calculation processing to obtain the pixel information of the block (step S1170), and also the color conversion processing of converting the color space of the pixel information thus obtained (step S1180). Here, when the DC component of the DCT coefficient is obtained, the DC component of the starting point restoring information is read in. Furthermore, the color conversion processing is the processing of converting a YCC color space used in the image file of the JPEG format to the RGB color space.

Subsequently, the block is clockwise rotated by 90° and output to the data buffer 24 (step S1190). When the data is output to the data buffer 24, the data is output so that the block itself is rotated and the position of the block is set to the position after the rotation (for example, the block at the upper left corner is set to be located at the upper right corner).

When the block is rotated and output as described above, the starting point restoring information of the block is updated to the starting point restoring information of the next block (a block located just at the right side of the block) (step S1200). That is, it is updated to the file pointer of the access unit at which the data of the next block is started, the decoding intermediate information and the DC component (see FIG. 11). With respect to the DC component, the quantized DC component of the present block is stored. Accordingly, when the next block is restored, the quantized DC component and the differential value obtained by subjecting the data of the next block to Huffman decoding are accumulated to obtain the quantized DC component of the next block.

The processing of the steps S1130 to S1200 is repetitively carried out until the post-rotation blocks output from the data buffer 24 are accumulated and they reach a band unit corresponding to a print execution unit of the printer engine 27 (step S1210). As described above, FIG. 12 is a diagram showing an aspect that the processing of the steps S1130 to S1200 is repetitively executed. As shown in FIG. 12, the processing of the steps S1130 to S1200 is sequentially repetitively executed on the blocks at the left end as the starting points from the upper end blocks, whereby the blocks at the upper end of the post-rotation image are output. When the processing on the blocks at the left end is finished, the processing of the steps S1130 to S1200 is sequentially repetitively executed on the blocks at the column located just at the right side of the blocks at the left end from the upper end blocks. When the accumulated post-rotation blocks thus accumulated reach the band unit as shown in FIG. 13, the print data is generated on the basis of the data of the band unit by the print data generator 25, and then output to the image buffer 26. The printer engine 27 carries out printing on the basis of the print data (step S1220). When the processing reaches the last block of the image file (step S1230), the image rotating and printing processing is finished.

According to the printer 20B of the second embodiment described above, in the case where a print instruction containing rotation of an image file, when the image file is added with starting point restoring information, the added starting point restoring information is read in, and when the image file is added with no starting point restoring information, the starting point restoring information obtaining processing is executed to obtain the starting point restoring information and adds it to the image file. Then, by using the starting point restoring information thus obtained, the post-rotation image of the image file is sequentially generated and printed from the upper end blocks. Accordingly, image files for which the starting point restoring information has been once obtained (image files on which the image rotating and printing processing has been once carried out) is added with starting point restoring information, and the next printing operation can be carried out by using the starting point restoring information thus added. As a result, it is unnecessary to repetitively carry out the processing of obtaining the starting point restoring information, so that the processing time needed to carry out the image processing on the image file can be shortened, and the image processing can be efficiently performed.

According to the printer 20B of the second embodiment, when the starting point restoring information is added to the image file, it is stored in an area at the rear side of the compressed data of the image (just after the marker segment EOI) and thus the starting point restoring information can be added without changing the physical position of the compressed data of the image. That is, the information such as the file pointer, etc., can be prevented from being displaced due to addition of the starting point restoring information. Furthermore, the starting point restoring information is stored at the last portion of the image file together with the data size. Therefore, even a printer which is not adapted to image files added with starting point restoring information can easily handle the image files by disregarding the added information.

Here, in the printer 20B of the second embodiment, the storage medium 30 or the like corresponds to the predetermined storage medium, and the controller 21 and the image processing module 23 for executing the steps S1100 to S1210 of the image rotating and printing processing and the starting point restoring information obtaining processing correspond to the image processing module, and the controller 21, the print data generator 25 and the printer engine 27 for executing the processing of the step S1220 of the image rotating and printing processing corresponds to the print executing module.

In the printer 20B of the second embodiment, the starting point restoring information is stored at the last portion of the image file. However, the starting point restoring information is not necessarily stored at the last portion insofar as it is restored in an area at the rear side of the compressed data of the image. Furthermore, it may be stored in an area at the front side of the compressed data of the image. In this case, for example, the information such as the file pointer, etc., of the starting point restoring information may be prevented from being displaced by securing an area for storing the starting point restoring information at the front side of the compressed data of the image in advance.

In the printer 20B of the first embodiment, the case where the clockwise rotation is made by 90° has been described as a specific example. However, the present invention is not limited to this case. For example when the rotation is made by 180°, the blocks at the left end as the starting point blocks are sequentially restored from the lower side, whereby the post-rotation blocks of the image can be sequentially output from the upper end block. Furthermore, in the case of the counterclockwise rotation of 90°, as shown in FIG. 14, the blocks on a column located substantially at the center of the image file are set as starting point blocks in addition to the blocks at the left end, and the upper half of the post-rotation image is restored with the starting point blocks on the column located substantially at the center as the starting points while the lower half of the post-rotation image is restored with the starting point blocks at the left end as starting points.

Next, a printer 20C according to a third embodiment of the present invention will be described. The printer 20C of the third embodiment has the same hardware construction as the printer 20 of the first embodiment. Therefore, the hardware construction of the printer 20C of the third embodiment is represented by the same reference numerals as the hardware construction of the printer 20 of the first embodiment, and the detailed description thereof is omitted.

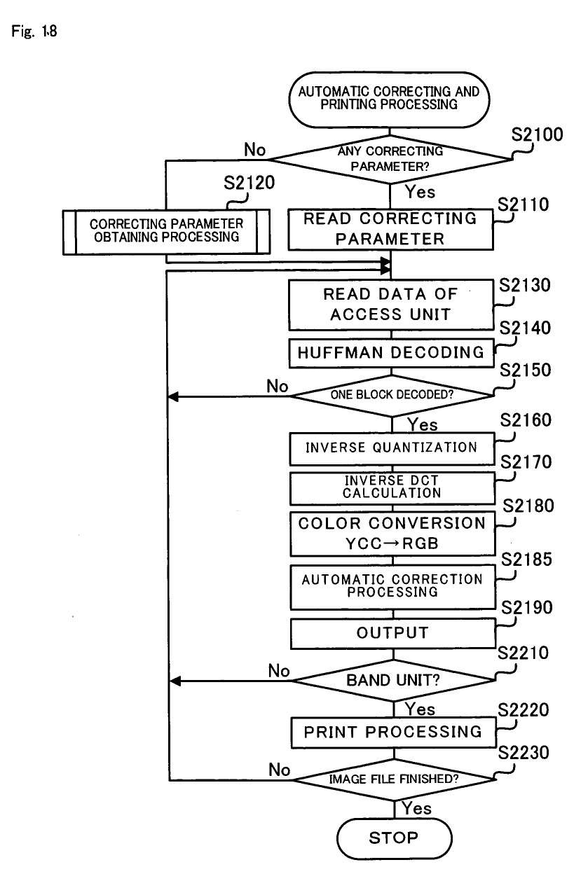

Next, the operation of the printer 20C of the third embodiment thus constructed, particularly the operation when the automatic correction processing is carried out on an image file read from the storage medium 30 or the like will be described. FIG. 18 is a flowchart showing an example of the automatic correction printing processing executed by the controller 21, the image processing module 23, the print data generator 25, etc., when the print instruction containing the automatic correction processing is made. As a case where such a print instruction is made, for example, a case may be considered where the setting of carrying out the automatic correction processing is carried out via an operating panel (not shown) of the printer 20C to instruct the printing, etc can be mentioned.

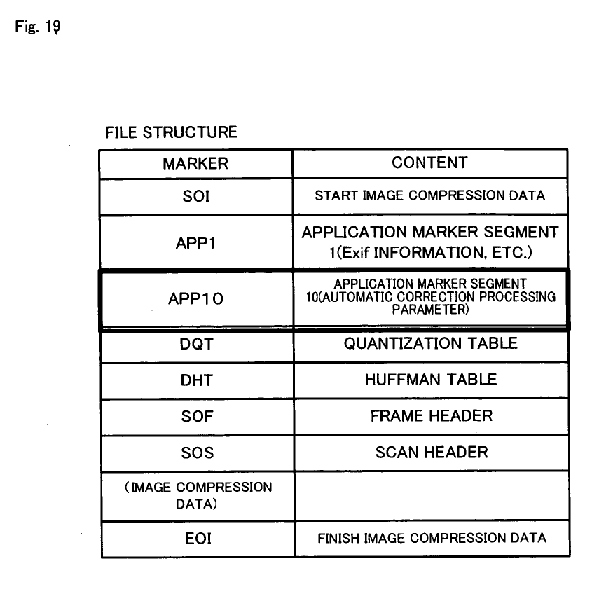

In the automatic correcting and printing processing, as shown in the figure, it is first judged whether the automatic correction processing parameter used for the automatic correction processing of an image file is added to the image file (step S2100). FIG. 19 is a diagram showing an example of the file structure of the image file of the JPEG format added with the automatic correction processing parameter. As described above, the image file of the JPEG format comprises a plurality of marker segments, and in the third embodiment the automatic correction processing parameter is stored as an application marker segment in APP10. The details of the automatic correction processing parameter and the processing of storing the automatic correction processing parameter will be described later. Accordingly in step S2100, it is judged whether the automatic correction processing parameter is added or not by judging whether the application marker segment APP10 exists or not.

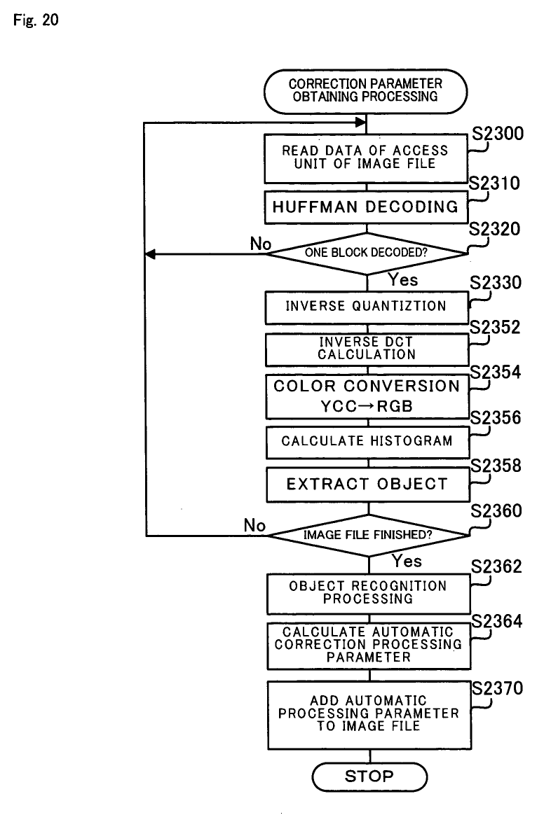

When the automatic correction processing parameter is added to the image file, the automatic correction processing parameter is read out from the image file and copied into the data buffer 24 (step S2110). When no automatic correction processing parameter is added to the image file, the correcting parameter obtaining processing to obtain the automatic correction processing parameter is executed (step S2120). Here, the description of the automatic correction and printing processing is interrupted, and the correcting parameter obtaining processing shown in FIG. 20 will be described.

In the correcting parameter obtaining processing, as in the case of the starting point restoring information obtaining processing of the second embodiment shown in FIG. 16, the data of one access unit of the image file according to a print instruction is first read out from the storage medium 30 or the like and subjected to Huffman decoding (steps S2300, S2310), and when the data of one block is decoded (step S2320), the inverse quantization processing is executed on the decoded data (step S2330) as shown in FIG. 20.

The inverse DCT calculation processing is carried out on the DCT coefficient obtained through the inverse quantization to obtain the pixel information of the block (steps s2352), and the color conversion processing is executed to convert the color space of the pixel information thus obtained to the RGB color space (step S2354). When the pixel information converted to the RGB color space is obtained, the histogram representing the distribution of the RGB values of the overall image file is accumulated and stored in the data buffer 24 (step S2356). The target pixels for which the accumulation of the histogram is carried out may be pixels sampled according to an appropriate rule.

Subsequently, an object area such as the face of a character or the like is extracted from the pixels of the present block, and stored in the data buffer 24 (step S2358). In the third embodiment, the extraction of the object area is based on the extraction of a flesh color area comprising the pixels of flesh color out of the pixels of the present blocks. The extraction of the flesh color area is carried out by presetting the RGB value range corresponding to the flesh color and extracting pixels within the RGB value range.

When the present block is not the last block of the image file, the processing returns to the step S2300 (step S2360), and the processing of the steps S2300 to S2358 is repetitively carried out on the next block. By sequentially restoring the image file from the head thereof as described above, the histogram of the RGB values is obtained, and the object area is extracted and stored in the data buffer 24.

When the processing of the steps S2300 to S2358 is repetitively carried out from the last block of the image file, the object recognition processing of judging on the basis of the object area extracted instep S2358 whether the image content is a character image or a scene image is carried out (step S2362). Various kinds of rules are applicable to the object recognition processing. In the third embodiment, the judgment of the character image or the scene image is made on the basis of the arrangement of the object area with respect to the overall image (for example, the object area comes into contact with the upper side or right or left side) or whether the pixel area corresponding to both the eyes or mouth exists in the object area.

When the image content is judged on the basis of the object recognition processing as described above, the automatic correction processing parameter for carrying out the automatic correction processing on the image file is calculated on the basis of the judged image content and the accumulated RGB value histogram, and stored in the data buffer 24 (step S2364). The calculation of the automatic correction processing parameter can be carried out by applying various kinds of rules. In the third embodiment, when the image content is a character image, the parameter is calculated so as to carry out flesh color correcting processing or soft focus processing for carrying out correction so that the flesh color is more excellent, brightness correction processing for carrying out correction so that the brightness is slightly enhanced, etc. When the image content is a scene image, the parameter is calculated so as to carry out tender green color correction processing for carrying out correction so that the tender green color is more excellent, color saturation correction processing for carrying out correction so that the color saturation is more vivid, etc. Furthermore, the parameter may be calculated so as to carry out various kinds of image correction processing (contrast correction processing, y correction processing, etc.,) in accordance with the RGB value histogram irrespective of whether the image content is the character image or the scene image.

The automatic correction processing parameter stored in the data buffer 24 is added to the image file (step S2370), and the correcting parameter obtaining processing is finished. When the automatic correction processing parameter is added to the image file, an application segment APP10 for storing the automatic correction processing parameter is created and stored just after the application segment APP1 of the image file as described above.

When the correction parameter obtaining processing is executed or the automatic correction processing parameter added to the image file in advance is read as described above, in the automatic correcting and printing processing, the data of one access unit is then read from the head of the image file, and subjected to Huffman decoding (steps S2130, S2140). When the data of one block is decoded (step S2150), the inverse quantization processing, the inverse DCT calculation processing and the color conversion processing are executed (steps S2160 to S2180).

Subsequently, the automatic correction processing is carried out on the block according to the automatic correction processing parameter thus obtained (step S2185), and then output to the data buffer 24 (step S2190). When the automatic correction processing is carried out, specifically, the image information is converted by using the lookup table corresponding to a conversion table of pixel information generated on the basis of the automatic correction processing parameter.

The processing of the steps S2130 to S2190 is repetitively carried out until the blocks output to the data buffer 24 are accumulated and reach the band unit corresponding to a unit for which the printing is executed by the printer engine 27 (step S2210). If the accumulated blocks reach the band unit, the print data are generated on the basis of the data of the band unit by the print data generator 25 and output to the image buffer 26, and the printing is executed on the basis of the print data by the printer engine 27 (step S2220). Then, when the processing reaches the last block of the image file (step S2230), the automatic correcting and printing processing is finished.

According to the printer 20C of the third embodiment described above, in the case where a print instruction containing the automatic correction processing on an image file is made, when the automatic correction processing parameter is added to the image file, the added automatic correction processing parameter is read in. When no automatic correction processing parameter is added to the image file, the correcting parameter obtaining processing is executed to obtain the automatic correction processing parameter and adds it to the image file, and the automatic correction processing is carried out on the image file by using the automatic correction processing parameter thus obtained to print the image file. Accordingly, the image files for which the automatic correction processing parameters have been once obtained (the image files on which the automatic correcting and printing processing has been once executed) are added with the automatic correction processing parameters, and the next printing operation can be carried out by using the added automatic correction processing parameters. As a result, it is unnecessary to repetitively carry out the processing of obtaining the automatic correction processing parameter, so that the processing time required to carry out the image processing on the image file can be shortened, and the image processing can be more efficiently performed.

Here, in the printer 20C of the third embodiment, the storage medium 30 or the like corresponds to the predetermined storage medium, the controller 21 and the image processing module 23 for executing the steps S2100 to S2210 of the automatic correcting and printing processing and the correcting parameter obtaining processing correspond to the image processing module, and the controller 21, the print data generator 25 and the printer engine 27 for executing the processing of the step S1220 of the automatic correcting and printing processing correspond to the print executing module.

In the printer 20C of the third embodiment, APP10 as the application marker segment for storing the automatic correction processing parameter is described, however, it is a matter of course that other application marker segments are used.

In the printer 20C of the third embodiment, the automatic correction processing parameter used for the automatic correction processing is added to the image file. However, any information is sufficient insofar as it is used for the automatic correction processing, and for example, the image file may be added with the pixel information converted to the RGB color space, the RGB value histogram, the lookup table generated on the basis of the automatic correction processing parameter or the like.

In the printer 20B of the second embodiment or the printer 20C of the third embodiment, the image file compressed in the JPEG format is described as an example. However, it is a matter of course that image files compressed in other formats may be applied.

In the printer 20B of the second embodiment and the printer 20C of the third embodiment, the starting point restoring information is stored at the last portion of the image file together with the data size, and the automatic correction processing parameter is stored in the application marker segment APP10 of the image file. However, the starting point restoring information may be stored in the application marker segment APP10, or the automatic correction processing parameter may be stored at the last portion of the image file together with the data size. Furthermore, the starting point restoring information or the automatic correction processing parameter may be embedded as a part of the image file, and thus these pieces of information may be embedded by other methods.

In the printer 20B of the second embodiment and the printer 20C of the third embodiment, the starting point restoring information is added to the image file, and the automatic correction processing parameter is added to the image file. However, it is a matter of course that both the starting point restoring information and the automatic correction processing parameter are added to the image file. Furthermore, information used for other image processing may be added to the image file insofar as the information is used when the image processing is carried out and can be collected on the basis of the image file.

In the printer 20B of the second embodiment and the printer 20C of the third embodiment, the starting point restoring information and the automatic correction processing parameter are stored at the last portion of the image file or the application marker segment APP10. However, it is unnecessary to embed these pieces of information as a part of the image file. For example, the starting point restoring information and the automatic correction processing parameter may be linked to the image file as a file based on a proper format, and stored in the storage medium 30 or the like. In this case, for example, they may be linked to the image file while the file names of the files of the starting point restoring information and the automatic correction processing parameter may be different from the file name of the image file in only the extension.

In the second embodiment, the invention in which the starting point restoring information and the automatic correction processing parameter are added to the image file has been described in the form of the printers 20B and 20C. However, it may be applied as an image processing apparatus for carrying out image processing. Furthermore, the invention may be applied in the form of an image processing method or in the form of an image processing program.

Next, a fourth embodiment of the present invention will be described. A printer 20D of the fourth embodiment has the same hardware construction as the printer 20 of the first embodiment shown in FIG. 1. In order to avoid the overlapping description, the hardware construction of the printer 20D of the fourth embodiment is represented by the same reference numerals as the hardware construction of the printer 20 of the first embodiment.

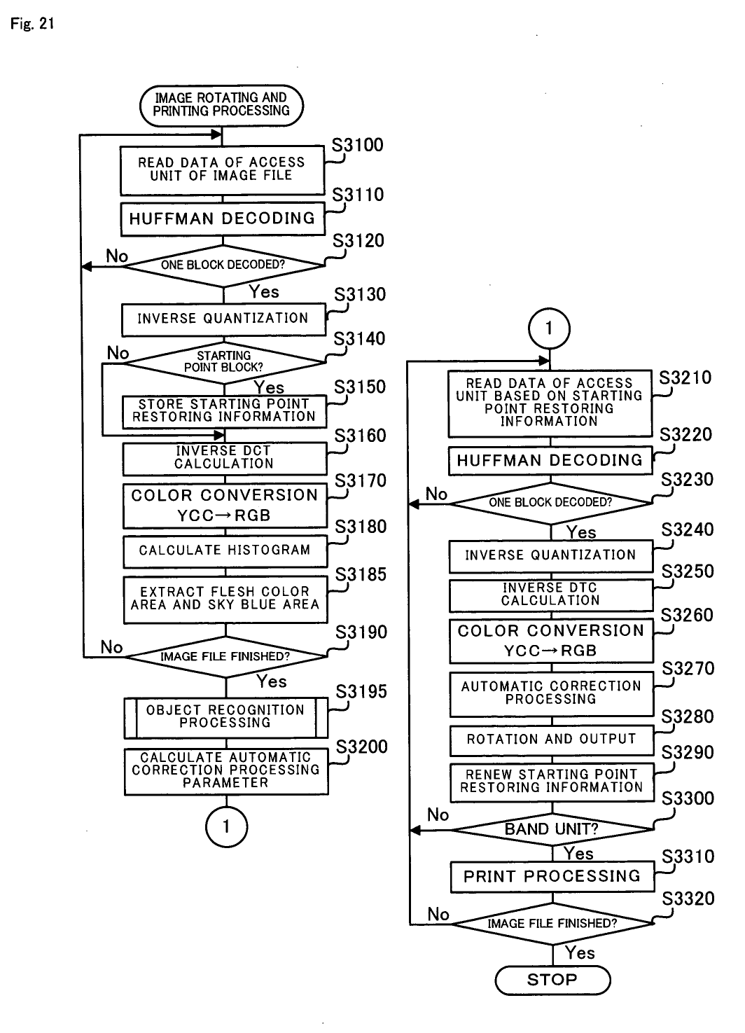

Next, the operation of the printer 20 of the fourth embodiment thus constructed, particularly, the operation when the image correction processing is carried out on the image file read out from the storage medium 30 and the image file thus processed is rotated and printed will be described. FIG. 21 is a flowchart showing an example of the image rotating and printing processing executed by the controller 21, the image processing module 23, the print data generator 25, etc., when a print instruction containing rotation of an image file is made. As the case where the print instruction containing the rotation of the image file is made, for example, a case may be considered where setting of printing layout requiring to rotate the image file is carried out through an operating panel (not shown) of the printer 20 to instruct printing or the like can be mentioned. Furthermore, in the fourth embodiment, a case where the image file is clockwise rotated by 90° will be described as a specific example.

In the image rotating and printing processing, as shown in the figure, data of one access unit of an image file associated with a print instruction is read in from the storage medium 30 or the like (step S3100), and the processing of subjecting the read-in data to Huffman decoding is carried out (step S3110). Here, the access unit is a read-in unit of data which is predetermined in accordance with the specification of the storage medium 30 or the like, and it corresponds to a sector in a flash memory or the like. Furthermore, as shown in FIG. 5, the data size of each block of an image file compressed in the JPEG format is not necessarily coincident with the access unit, and the data size is different among respective blocks. Therefore, the data of one block may extend over a plurality of access units.

The processing of reading in the data of the access unit and then subjecting the read-in data to Huffman decoding is repetitively executed until the data of one block is subjected to Huffman decoding. When the data of one block is decoded (step S3120), the inverse quantization processing is executed on the decoded data (quantization DCT coefficient of the block) (step S3130). The DCT coefficient of the block is obtained by executing the inverse quantization processing. Here, in the image file of the JPEG format, with respect to the quantized DC component of the quantization DCT coefficient, the differential value between the blocks is subjected to Huffman decoding. Therefore, the quantized DC component is obtained by accumulating the differential value of the quantized DC component obtained through Huffman decoding, and the inverse quantization processing is carried out on the quantized DC component to obtain the DC component.

Next, it is judged whether the present block is a starting point block (step S3140). Here, the starting point block is a block serving as a starting point to restore the image file from the some midpoint thereof, and in the fourth embodiment, a block at the left end which will become a block at the upper end when the image is clockwise rotated by 90° is set as a starting point block (see FIG. 6).

When the present block is a starting point block, the starting point restoring information for restoring the image file with the block set as a starting point is stored in a working area of the data buffer 24 (step S3150). The starting point restoring information is specifically constructed by a file pointer for indicating the access-unit based physical position from which the data of the starting point block is started, decoding intermediate information for Huffman-decoding the data of the starting point block from the access unit and the DC component of the starting point block. As described above, FIG. 7 is a diagram showing the concept of the decoding intermediate information. As described previously, the data size of each block and the access unit are not necessarily coincident with each other, and the data size is different among the blocks, so that the access unit in which the data of the starting point block is started contains the data of the preceding block. Accordingly, in order to Huffman-decode the data of the starting point block, information concerning Huffman decoding of the data of the preceding block (for example, Huffman-decoded bit number as data of the preceding data, etc.,) is needed, and the information as described above corresponds to the decoding intermediate information.

Subsequently, the inverse DCT calculation processing is carried out on the DCT coefficient obtained through the inverse quantization processing of the step S3130 to obtain the pixel information of the block (step S3160), and also the color conversion processing of converting the color space of the pixel information thus obtained is carried out (step S3170). Here, the color conversion processing is the processing of converting the YCC color space used for the image file of the JPEG format to the RGB color space.

When the pixel information converted to the RGB color space is obtained, the histogram representing the distribution of the RGB values of the overall image file is accumulated, and stored in a predetermined area of the data buffer 24 (step S3180). The target pixels for which the histogram is accumulated may be pixels sampled according to an appropriate rule.

Subsequently, a flesh color area comprising pixels of flesh color or a sky blue area comprising pixels of sky blue are extracted from the pixels of the present block, and stored in a predetermined area of the data buffer 24 (step S3185). Here, the extraction of the flesh color area or the sky blue area is carried out by predetermining the RGB value range corresponding to the flesh color or the sky blue and extracting the pixels within the RGB value range.

When the present block is not the last block of the image file, the processing returns to the step S3100 (step S3190), and the processing of steps S3100 to S3185 is repetitively carried out on the next block. As described above, FIG. 8 is a diagram showing an example of the starting point restoring information when the processing of steps S3100 to S3185 is repetitively executed. As shown in FIG. 8, in the fourth embodiment, the blocks at the left end of the image are set as the starting point blocks, and thus the starting point restoring information for the blocks at the left end (the file pointer, the decoding intermediate information and the DC component) is sequentially stored from the upper block. As described above, by sequentially restoring the image file from the head thereof, the starting point restoring information and the RGB value histogram are obtained, the flesh color area and the sky blue area are extracted, and they are stored in the data buffer 24.

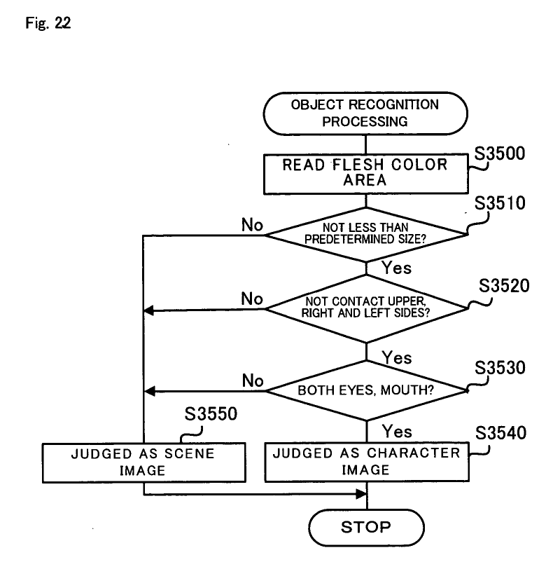

When the processing of the steps S3100 to S3185 is repetitively carried out until the last block of the image file as described above, the object recognition processing of judging on the basis of the flesh color area extracted in step S3185 whether the image content is a character image or scene image is carried out (step S3195). Here, the description of the image rotating and printing processing is interrupted, and the object recognition processing shown in FIG. 22 will be described.

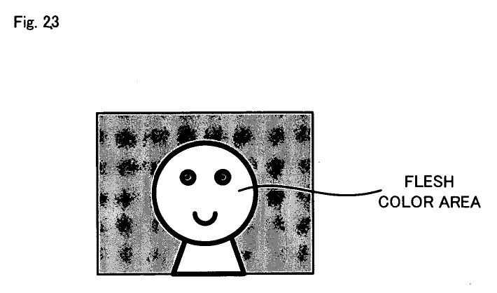

In the object recognition processing, the processing of reading the information concerning the flesh color area extracted in step S3185 of the image rotating and printing processing is first executed as shown in FIG. 22 (step S3500). FIG. 23 shows an example of the flesh color area. It is judged whether the size of the flesh color area is not less than a predetermined size, it is judged whether the flesh color area comes into contact with the upper side or the right and left sides, and also it is judged whether the pixel area corresponding to both the eyes or mouth of a character exists in the flesh color area (steps S3510 to S3530). Here, the predetermined size may be set by using the area ratio of the flesh color area to the overall image, and in the fourth embodiment, a size of 20% of the overall image is set to the predetermined size. The judgment whether the pixel area corresponding to both the eyes or mouth exists or not is carried out as follows. That is, pixel areas which contain some of the pixels of the flesh area and are lower in brightness than the surrounding pixels are extracted, and when the pixel areas having the low brightness exist at apex positions of a substantially inverse triangle (that is, two positions arranged laterally and one position lower than the two positions), these pixel areas are judged as being the pixel areas corresponding to both the eyes and the mouth.

When the size of the flesh area is not more than the predetermined size, the flesh area never comes into contact with the upper side and the right and left sides, and the pixel areas corresponding to both the eyes and the mouth exist, the image content is judged as a character image (step S3540). In the other cases, the image content is judged as a scene image (step S3550), and the object recognition processing is finished. In the flesh area shown in FIG. 23, there exist the pixel areas whose size is not less than 20% of the overall image and which do not come into contact with the upper side and the right and left sides of the image and correspond to both the eyes and the mouth, and thus the image content of the image is judged as a character image.

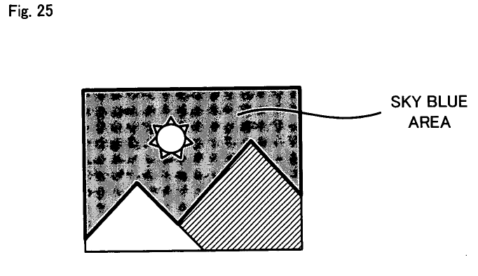

When the image content is judged through the object recognition processing, the automatic correction processing parameter to subject the image file to the automatic correction processing is calculated on the basis of the judged image content and the accumulated RGB value histogram, etc., and is stored in a predetermined area of the data buffer 24 (step S3200). The calculation of the automatic correction processing parameter can be carried out by applying various kinds of rules. In the fourth embodiment, when the image content is a character image, the parameter is calculated so as to carry out flesh color correcting processing or soft focus processing for carrying out correction so that the flesh color is more excellent and brightness correction processing for carrying out correction so that the brightness is slightly enhanced, etc. When the image content is a scene image, the parameter is calculated so as to carry out tender green color correction processing for carrying out correction so that the tender green color is more excellent, color saturation correction processing for carrying out correction so that the color saturation is more vivid, etc. Furthermore, when the image content is the scene image, the sky blue area is judged as sky if the sky blue area extracted in step S3185 does not come into contact with the lower side of the image, and the parameter is calculated so as to carry out the sky blue correction processing for carrying out correction so that the sky blue is more excellent (see FIG. 25). The parameter may be calculated so that various kinds of image correction processing (contrast correction processing, y correction processing, etc.,) is carried out in accordance with the RGB value histogram irrespective of whether the image content is the character image or the scene image.

Subsequently, the file pointer of the first starting point block out of the starting restoring information stored in the data buffer 24 is read in (step S3210), and the data of the access unit specified on the basis of the read-in file pointer is read from the storage medium 30 or the like and subjected to Huffman decoding (step S3220). At this time, by using the decoding intermediate information of the starting point restoring information, the data of the starting point block out of the data of the access unit can be decoded.

When the data of one block is decoded (step S3230), the inverse quantization processing, the inverse DCT calculation processing and the color conversion processing are executed (steps S3240 to S3260). Here, when the DC component of the DCT coefficient is obtained, the DC component of the starting point restoring information is read in.

Subsequently, the block is subjected to the automatic correction processing according to the automatic correction processing parameter calculated in step S3200 (step S3270), rotated clockwise by 90° and then output to a predetermined area of the data buffer 24 (step S3280). When the block is output to the predetermined area of the data buffer 24, the block itself is rotated and output so that the position of the block is set to the position after the rotation (for example, the block at the upper left corner is set to be located at the upper right corner).

When the block is rotated and output as described above, the starting point restoring information of the block is updated to the starting point restoring information of the next block (the block located just at the right side of the block) (step S3290). That is, the starting point restoring information is updated to the file pointer of the access unit at which the data of the next block is started, the decoding intermediate information and the DC component (see FIG. 11). With respect to the DC component, the quantized DC component of the present block is stored. Accordingly, when the next block is restored, the quantized DC component and the differential value obtained by subjecting the data of the next block to Huffman decoding are accumulated to thereby obtain the quantized DC component of the next block.

The processing of the steps S3210 to S3290 is repetitively carried out until post-rotation blocks output to the predetermined area of the data buffer 24 are accumulated and the accumulation result reaches a band unit corresponding to a unit to be printed by the printer engine 27 (step S3300). As described above, FIG. 12 is a diagram showing an aspect that the processing of the steps S3210 to S3290 is repetitively carried out. As shown in FIG. 12, the processing of the steps S3210 to S3290 is sequentially carried out on each block at the left side as a starting point block from the upper end blocks, thereby outputting the blocks at the upper end of the post-rotation image. When the processing to be carried out on the blocks at the left end is finished, the processing of the steps S3210 to S3290 is repetitively carried out on blocks on the column located at the right side of the left-end blocks. When the accumulated post-rotation blocks reach a band unit as shown in FIG. 13, print data is generated on the basis of the data of the band unit by the print data generator 25, and output to the image buffer 26. The printer engine 27 carries out printing on the basis of the print data (step S3310). Then, when this processing reaches the last block of the image file (step S3320), the image rotating and printing processing is finished.

According to the printer 20D of the fourth embodiment described above, when the image file is subjected to the image correction processing and also printed while being rotated, the image file is sequentially restored from the head thereof to obtain the starting point restoring information and the RGB value histogram, and the flesh area or the like is extracted and stored in the data buffer 24. On the basis of the size of the flesh color area and existence of the pixel area corresponding to both the eyes or mouth, it is judged whether the image content is a character image or scene image, and the automatic correction processing parameter is calculated. The image file is restored from the starting point block by using the starting point restoring information to sequentially generate the post-rotation image from the upper end, and the image thus generated is subjected to the automatic correction processing according to the calculated parameter and output. Accordingly, the judgment of the image content is carried out by using the image before the rotation, and thus the image content can be more properly judged. As a result, the image correction processing when the image is rotated and output can be more properly performed.

Here, in the printer 20D of the fourth embodiment, the data buffer 24 corresponds to the data storage module, the controller 21 and the image processing module 23 for executing the processing of steps S3100 to S3190 correspond to the information calculation obtaining module, the controller 21 and the image processing module 23 for executing the object recognition processing of the step S3195 correspond to the image content judging module, and the controller 21 and the image processing module 23 for executing the processing of steps S3200 to S3300 corresponds to the image correcting and rotating module. Furthermore, the interface portion 22 corresponds to the data obtaining module, and the controller 21, the print data generator 25 and the printer engine 27 for executing the processing of step S3310 correspond to the print executing module. Furthermore, the flesh color area corresponds to the object area.

In the printer 20D of the fourth embodiment, the flesh color area comprising the pixels of flesh color is extracted and used to judge the image content. However, the object area corresponding to the face of a character may be extracted, so that the object area may be extracted on the basis of other references. For example, edge pixels in which the edge degree based on the brightness difference from adjacent pixels is larger than a predetermined threshold value may be extracted as an object area.

In the printer 20D of the fourth embodiment, the image content is judged as a character image on the basis of a condition that the flesh color area does not come into contact with the upper side and the right and left sides. However, the flesh color area may come into slight contact with the upper side or the right and left sides.

In the printer 20D of the fourth embodiment, the image content is judged as a character image on the basis of whether the size of the flesh color area is not less than the predetermined size, whether the flesh color area comes into contact with the upper side or the right and left sides, or whether the pixel area corresponding to both the eyes or mouth of a character exists within the flesh color area. However, the present invention is not limited to this style. When any one or two of the above conditions are satisfied, the image content may be judged as a character image, or other conditions may be used.

In the printer 20D of the fourth embodiment, when the image content is not judged as a character image, it is judged as a scene image. However, it is a matter of course that the present invention is not limited to this style. For example, the image content may be judged a scene image on the basis of the arrangement of the sky blue area or the like. Furthermore, an image content other than the character image and the scene image may be judged.

In the printer 20D of the fourth embodiment, the image file compressed in the JPEG format is described as an example. However, it is a matter of course that the present invention is applicable to an image file compressed in other formats. In this case, in accordance with the compression format, information needed to restore an image file from a predetermined position (for example, pixels at the left end) may be stored as starting point restoring information.

In the printer 20D of the fourth embodiment, the case where the clockwise rotation is made by 90° has been described as a specific example. However, the present invention is not limited to this case. For example when the rotation is made by 180°, the blocks at the left end as the starting point blocks are sequentially restored from the lower side, whereby the post-rotation blocks of the image can be sequentially output from the upper end block. Furthermore, in the case of the counterclockwise rotation of 90°, as shown in FIG. 14, the blocks on a column located substantially at the center of the image file are set as starting point blocks in addition to the blocks at the left end, and the upper half of the post-rotation image is restored with the starting point blocks on the column located substantially at the center as the starting points while the lower half of the post-rotation image is restored with the starting point blocks at the left end as starting points.

In the printer 20D of the fourth embodiment, the image file is restored from the starting point block by using the starting point restoring information obtained by sequentially restoring the image file from the head thereof, whereby the post-rotation image is sequentially generated from the upper end. However, it is a matter of course that the image is not necessarily rotated as described above. For example, the processing of restoring the overall image and then rotating it may be carried out.

The fourth embodiment has been described in the form of the printer 20D of the present invention in which the judgment of the image content is carried out by using an image before rotation. However, the present invention may be applied in the form of an image processing apparatus for carrying out the image correction processing as described above. Furthermore, it may be applied in the form of an image processing and in the form of an image processing program.

The best modes for carrying out the present invention have been described by using the embodiments. However, the present invention is not limited to these embodiments, and the present invention can be implemented in various styles without departing from the gist of the present invention.

The specification hereof refers to Japanese Patent Application No. 2004-282534 (filed on Sep. 28, 2004), No. 2004-282535 (filed on Sep. 28, 2004) and No. 2004-282536 (filed on Sep. 28, 2004), and incorporates herein all the details of the specifications, the drawings, and the claims disclosed therein.

What is claimed is:

1. An image processing apparatus for subjecting an image file to predetermined image processing and then outputting the image file thus processed, comprising:
an information storage module for storing pre-collection information in association with an image file, the pre-collection information being used when the image file is subjected to the predetermined image processing and the pre-collection information collectable on the basis of the image file; and
an image processing module in which when it is instructed to subject a designated image file of image files stored in a predetermined storage medium to predetermined image processing, and wherein when pre-collection information associated with the image file does not exist in the information storage module, the pre-collection information is collected on the basis of the designated image file and stored in association with the image file in the information storage module, and the image file is subjected to the predetermined image processing by using the pre-collection information and then output, and when pre-collection information associated with the image file exists in the information storage module, the image file is subjected to the predetermined image processing by using the pre-collection information and then output.

2. The image processing apparatus according to claim 1, further comprising
an information clear module for clearing the pre-collection information stored in the information storage module at a predetermined timing.

3. The image processing apparatus according to claim 2, wherein
the predetermined storage medium is detachably mounted in the image processing apparatus, and the predetermined timing is set to at least one of mounting and detaching timings of the predetermined storage medium.

4. The image processing apparatus according to claim 1, wherein
the information storage module stores the pre-collection information in association with the image file by using a corresponding relationship managing table for managing the corresponding relationship between identification information of the image file and identification information of the pre-collection information.

5. The image processing apparatus according to claim 4, wherein
the identification information of the image file is address information indicating the physical position of the image file in the predetermined storage medium.

6. The image processing apparatus according to claim 4, wherein
the identification information of the pre-collection information is address information indicating the physical position of the pre-collection information in the information storage module.

7. The image processing apparatus according to claim 1, wherein
the image file is compressed in a predetermined format, and the pre-collection information is information that can be collected by sequentially restoring the image file from the head thereof.

8. The image processing apparatus according to claim 7, wherein
the predetermined image processing is image automatic correction processing of sequentially restoring the image file from the head thereof to obtain pixel information, calculating characteristic information indicating the characteristics of the image file on the basis of the pixel information thus obtained, calculating a correcting parameter on the basis of the characteristic information thus calculated, generating a lookup table for converting the pixel information on the basis of the correcting parameter, and converting the pixel information of the image file on the basis of the lookup table thus generated to correct the image file, and the pre-collection information is any one of the pixel information, the characteristic information, the correcting parameter and the lookup table.

9. The image processing apparatus according to claim 7, wherein
the predetermined image processing is rotated image generating processing of sequentially restoring the image file from the head thereof to obtain starting point restoring information for restoring the image file with a predetermined position of the image file as a starting point, and restoring the image file with the predetermined position as the starting point on the basis of the starting point restoring information thus obtained, whereby a post-rotation image when the image is rotated in a predetermined direction by a predetermined angle is sequentially generated from the upper end, and the pre-collection information is the starting point restoring information.

10. The image processing apparatus according to claim 1, wherein
the information storage module stores the pre-collection information in association with the combination of the image file and a processing pattern of the predetermined image processing, and an instruction for subjecting to the predetermined image processing is an instruction containing an indication of the processing pattern of the predetermined image processing, and wherein when the pre-collection information relating to the combination of the image file and the processing pattern does not exist in the information storage module, the image processing module collects the pre-collection information on the basis of the image file and the processing pattern, stores the pre-collection information thus collected in association with the combination of the image file and the processing pattern in the information storage module, subjects the image file to predetermined image processing by using the pre-collection information and outputs the image file thus processed, and when the pre-collection information relating to the combination of the image file and the processing pattern exists in the information storage module, the image file is subjected to the predetermined image processing by using the pre-collection information.

11. A method for controlling an image processing apparatus having an information storage module for storing information, wherein
in a case where it is instructed that predetermined image processing is carried out on an image file designated from image files stored in a predetermined storage medium, when the pre-collection information relating to the image file does not exist in the information storage module, the pre-collection information is collected on the basis of the image file and stored in association with the image file in the information storage module, and the image file is subjected to the predetermined image processing by using the pre-collection information and then output, while when the pre-collection information relating to the image file exists in the information storage module, the image file is subjected to the predetermined image processing by using the pre-collection information and then output.

12. A storage medium for storing therein an image processing program that is installed in an image processing apparatus having an information storage module for storing information to subject an image file to predetermined image processing and output the image file thus processed, wherein
in a case where it is instructed that predetermined image processing is carried out on an image file designated from image files stored in a predetermined storage medium, when the pre-collection information relating to the image file does not exist in the information storage module, the image processing program collects the pre-collection information on the basis of the image file and stores the pre-collection information thus collected in association with the image file in the information storage module, subjects the image file to the predetermined image processing by using the pre-collection information and then output, the image file thus processed, while when the pre-collection information relating to the image file exists in the information storage module, the image processing program subjects the image file to the predetermined image processing by using the pre-collection information and outputs the image file thus processed.

13. An image processing apparatus for subjecting an image file to predetermined image processing and outputting the image file thus processed, wherein
in a case where it is instructed that predetermined image processing is carried out on a designated image file of image files stored in a predetermined storage medium, when the image file is beforehand added with pre-collection information that is used to carry out the predetermined image processing and collectable on the basis of the image file, the image file is subjected to the predetermined image processing by using the pre-collection information thus added and then output, and when the pre-collection information is not beforehand added to the image file, the pre-collection information is collected on the basis of the image file, the image file is added with the pre-collection information thus collected and stored in the predetermined storage medium, and the image file is subjected to the predetermined image processing by using the pre-collection information and then output.

14. The image processing apparatus according to claim 13, wherein
the image processing module embeds the pre-collection information as a part of the image file to add the pre-collection information to the image file.

15. The image processing apparatus according to claim 14, wherein
the image processing module embeds the pre-collection information in an area at the rear side of an image data storing area in each area constituting the image file to thereby add the pre-collection information to the image file.

16. The image processing apparatus according to claim 14, wherein
the image processing module embeds the pre-collection information at the last portion of the image file to thereby add the image file with the pre-collection information.

17. The image processing apparatus according to claim 14, wherein
the image file is a file based on the JPEG format, and the image processing module embeds the pre-collection information in an application marker segment in the JPEG format to thereby add the image file with the pre-collection information.

18. The image processing apparatus according to claim 13, wherein
the image processing module stores the pre-collection information as a pre-collection information file based on a predetermined format that is linked to the image file, thereby adding the image file with the pre-collection information.

19. The image processing apparatus according to claim 18, wherein
the image processing module sets the file name of the pre-collection information file by using at least a part of the file name of the image file, thereby linking the pre-collection information file and the image file to each other.

20. The image processing apparatus according to claim 13,
wherein the image file is compressed in a predetermined format, and the pre-collection information is information that can be collected by sequentially restoring the image file from the head thereof.

21. The image processing apparatus according to claim 20, wherein
the predetermined image processing is image automatic correction processing of sequentially restoring the image file from the head thereof to obtain pixel information, calculating characteristic information representing the characteristics of the image file on the basis of the pixel information thus obtained, calculating a correcting parameter on the basis of the characteristic information thus calculated, generating a lookup table for converting the pixel information on the basis of the correcting parameter thus calculated, and converting the pixel information of the image file on the basis of the lookup table thus generated to correct the image file, and the pre-collection information is any one of the pixel information, the characteristic information, the correcting parameter and the lookup table.

22. The image processing apparatus according to claim 20, wherein
the predetermined image processing is rotated image generating processing for sequentially restoring the image file from the head thereof to obtain starting point restoring information for restoring the image file with a predetermined position of the image file set as a starting point, and restoring the image file with the predetermined position as the starting point on the basis of the starting point restoring information thus obtained, whereby a post-rotation image when the image is rotated in a predetermined direction by a predetermined angle is sequentially generated from the upper end, and the pre-collection information is the starting point restoring information.

23. An image processing method for subjecting an image file to predetermined image processing and outputting the image file thus processed, wherein
in a case where it is instructed that predetermined image processing is carried out on a designated image file of image files stored in a predetermined storage medium, when the image file is beforehand added with pre-collection information that is used to carry out the predetermined image processing and collectable on the basis of the image file, the image file is subjected to the predetermined image processing by using the pre-collection information thus added and then output, and when the pre-collection information is not beforehand added to the image file, the pre-collection information is collected on the basis of the image file, the image file is added with the pre-collection information thus collected and stored in the predetermined storage medium, and the image file is subjected to the predetermined image processing by using the pre-collection information and then output.

24. A storage medium stored with an image processing program for subjecting an image file to predetermined image processing and outputting the image file thus processed, wherein
in a case where it is instructed that predetermined image processing is carried out on a designated image file of image files stored in a predetermined storage medium, when the image file is beforehand added with pre-collection information that is used to carry out the predetermined image processing and collectable on the basis of the image file, the image processing program subjects the image file to the predetermined image processing by using the pre-collection information thus added and then outputs, and when the pre-collection information is not beforehand added to the image file, the image processing program collects the pre-collection information on the basis of the image file, adds the image file with the pre-collection information thus collected and stored in the predetermined storage medium, subjects the image file to the predetermined image processing by using the pre-collection information and then outputs the image file thus processed.

25. An image processing apparatus for subjecting an image to predetermined image correction processing, comprising:
an image content judging module for extracting an object area contained in a designated image on the basis of pixel information of the image when an output instruction containing rotation of the designated image is made, and judging the image content of the image on the basis of the arrangement of the object area thus extracted with respect to the overall image; and
an image correcting and rotating module for subjecting the designated image to predetermined image correction processing on the basis of the image content thus judged and rotating and outputting the image.

26. The image processing apparatus according to claim 25, wherein
the image content judging module extracts an area comprising pixels of predetermined flesh color as the object area, and judges whether the image content of the image is the image of a character on the basis of the arrangement of the object area with respect to the overall image.

27. The image processing apparatus according to claim 25, wherein
the image content judging module judges whether the image content of the image is the image of a character on the basis of a condition that a contact amount by which the extracted object area comes into contact with the upper side and the right and left sides of the image is not more than the predetermined amount.

28. The image processing apparatus according to claim 25, wherein
the image content judging module judges whether the image content of the image is the image of a character on the basis of a condition that laterally arranged areas corresponding to both eyes of the character and an area that is located below the areas and corresponds to a mouth of the character exist.

29. The image processing apparatus according to claim 25, wherein
when the image content of the image is not judged as the image of a character, the image content judging module judges that the image content of the image is the image of a scene.

30. The image processing apparatus according to claim 25, wherein
when the image content of the image is the image of a scene, the image correcting and rotating module subjects the image to sky blue correction processing of correcting the predetermined sky blue on the basis of a condition that pixels of predetermined sky blue do not come into contact with the lower side of the image.

31. The image processing apparatus according to claim 25, wherein
the image is compressed in a predetermined format, and the image processing apparatus is equipped with a data storage module for storing data, and an information calculating and obtaining module for sequentially restoring the designated image from the head thereof until at least the pixel information can be obtained, the pixel information thus obtained is stored in the data storage module, and starting point restoring information for restoring the image with a predetermined position of the image as a starting point is obtained and stored in the data storage module, and wherein the image content judging module extracts an object area contained in the image on the basis of the pixel information stored in the data storage module, and the image correcting and rotating module restores the image with the predetermined position as a starting point on the basis of the starting point restoring information stored in the data storage module to sequentially generate a post-rotation image from the upper end, and subjects the post-rotation image to the predetermined image correction processing and then output the image.

32. An image processing method for subjecting an image to predetermined image correction processing and outputting the image, comprising:
(a) extracting an object area contained in a designated image on the basis of pixel information of the image when an output instruction containing rotation of the designated image is made, and judging the image content of the image on the basis of an arrangement of the extracted object area with respect to the whole image; and
(b) subjecting the designated image to the predetermined image correction processing on the basis of the judged image content, and rotating and outputting the image.

33. A recording medium storing an image processing program for subjecting an image to predetermined image processing and outputting the image, the image processing program comprising:
an image content judging module for extracting an object area contained in a designated image on the basis of pixel information of the image and judging the image content of the image on the basis of an arrangement of the extracted object area with respect to the whole image when an output instruction containing rotation of the designated image is made; and
an image correcting and rotating module for subjecting the designated image to the predetermined image correction processing on the basis of the judged image content, and rotating and outputting the image.
